(19) United States
(12) Patent Application Publication
(10) Pub. No.: US 2023/0315952 A1
(43) Pub. Date: Oct. 5, 2023

(54) SYSTEM AND METHOD FOR CREATION OF A PROJECT MANIFEST IN A COMPUTING ENVIRONMENT

(71) Applicant: Slate Technologies Inc., Pleasanton, CA (US)

(72) Inventor: Senthil Manickavasagam Kumar, Dublin, CA (US)

(21) Appl. No.: 18/116,017

(22) Filed: Mar. 1, 2023

Related U.S. Application Data
(60) Provisional application No. 63/316,609, filed on Mar. 4, 2022.

(51) Int. Cl. G06F 30/27; G06Q 10/10

(52) U.S. Cl. CPC G06F 30/27; G06Q 10/103; G06F 2111/04

(57) ABSTRACT

A method for creating a project manifest in a computing environment includes receiving a request related to a project, determining one or more project objectives related to the request, determining a set of constraints for the project, correlating the determined set of constraints with the one or more project objectives, evaluating the correlated set of constraints and the one or more project objectives to generate an optimized model, and creating a project manifest based on the optimized model for executing the project.

### RELATED APPLICATION(S)

This application claims priority under 35 U.S.C. § 119(e) of the co-pending U.S. Provisional Pat. Application Serial No. 63/316,609, filed Mar. 04, 2022, and titled “System and Method for Design, Manufacture, and Customization of Construction Assemblies” which is hereby incorporated by reference in its entirety.

This application is related to U.S. Provisional Application No. 63/280,881, filed Nov. 18, 2021, and titled “Method and System for Multi-Factor Optimization of Schedules and Resource Recommendations for Smart Construction Utilizing Human and Machine Cognition,” U.S. Pat. Application No. 17/683,858, filed Mar. 1, 2022, and titled “Intelligence Driven Method and System for Multi-Factor optimization of Schedules and Resource Recommendations for Smart Construction,” U.S. Provisional Application No. 63/324,715, filed Mar. 29, 2022, and titled “System and methods for intent-based factorization and computational simulation,” U.S. Pat. Application No. 17/894,418, filed Aug. 24, 2022, and titled “System and Method for Computational Simulation and Augmented/Virtual Reality in a Construction Environment,” and U.S. Pat. Application No. 18/107,653, filed Feb. 9, 2023, and titled “System and Method for Manufacture and Customization of Construction Assemblies in a Computing Environment,” the entire contents of which are hereby incorporated by reference for all purposes as if fully set forth herein.

### FIELD OF THE INVENTION

The present disclosure relates generally to artificial intelligence driven project optimization schemes, Computer Aided Design (CAD), Computer Aided Manufacturing (CAM), use of Building Information Models (BIMs), and general project manifests for construction projects. Specifically, the present disclosure relates to industrialized construction, streamlining, and optimizing the design to meet an architect’s design intent and optimize for manufacturing and/or assembly process of construction artefacts or assemblies for construction projects. The present disclosure is generally related to artificial intelligence (AI) and machine learning (ML) in a construction environment. In particular, the disclosure relates to the implementation and use of ML, AI, cognitive systems, self-learning, and trainable systems for intent-based factorization and computational simulation for optimal construction and/or manufacturing project execution. Further, the present disclosure is generally related to creation of project (construction and/or production) manifests in a computing environment.

### BACKGROUND OF THE INVENTION

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Conventionally, in the manufacturing and/or construction industry, the management of projects has always been complex and involves optimizing several variables that impact the schedule, cost, quality, etc., of the projects. In particular, the management of a construction project involves consumption and/or prefabrication of several construction artefacts or assemblies for the building construction, which proves to be suboptimal in many cases. For example, materials for construction artefacts or assemblies must be procured, transferred to a construction site, assembled, etc., which create dependencies on supply chain, labor, and other aspects that may be inefficient, unmonitored, and lead to cost and schedule overruns, quality degradation, etc.

Software solutions may be used for every step or stage of a project, from planning to designing to actual execution. A final output of the software may be simulated logistics of the project and represented through a spreadsheet or a diagrammatic representation. By using the software and accessing such final output, users can understand the relationships between buildings, building materials, and other systems in a variety of situations and attempt to account for them in their decision-making processes.

However, when confronted with a multitude of diverse input, conventional solutions are unable to adapt or make decisions in real-time or near real-time to account for the dynamic nature of a construction and/or a manufacturing project. In an example, parsing of a user query provided as a natural language input to drive the output requires an interfacing with state-of-the-art parsers such as language processors. The same rationale applies when it comes to attempting to drive the output of the software based on a user intent, which may not be an explicit but an implicit input.

As discussed above, conventional systems rely on manual and rule-based approaches (such as accepting only certain user inputs) for generating specific scenario-based outcomes. Accordingly, these conventional systems fail to comprehend dynamic variations in factors impacting manufacturing and/or construction and may fail to provide any meaningful insights or actionable guidance to improve the execution of the project (in an example, in terms of cost, timeline, quality, sustainability etc.). These problems are further compounded when factors that impact the construction schedule, budget, and design are many and varied. Some of these factors are near impractical to predict, plan, and accommodate until the factors come to pass or are likely to come to pass with some degree of certainty.

Accordingly, there is a need for technical solutions that address the needs described above, as well as other inefficiencies of the state of the art. Accordingly, there is a need in the art to improve and execute manufacturing and/or construction cycles of projects more efficiently. There is a need for a system, an apparatus, and a method for creation of an optimized project manifest associated with a construction and/or manufacturing project. Further, there is a need to give visibility of project outcomes to the concerned users in real time. There is also a need to better automate the project execution and reduce the risk of human error when reconfiguring data associated with a project.

### SUMMARY OF THE INVENTION

The following represents a summary of some embodiments of the present disclosure to provide a basic understanding of various aspects of the disclosed herein. This summary is not an extensive overview of the present disclosure. It is not intended to identify key or critical elements of the present disclosure or to delineate the scope of the present disclosure. Its sole purpose is to present some embodiments of the present disclosure in a simplified form as a prelude to the more detailed description that is presented below.

Embodiments of an AI-based system and a corresponding method are disclosed that address at least some of the above challenges and issues. The present disclosure improves and makes a construction cycle of a construction project more efficient by creating an optimized project manifest associated with a manufacturing and/or a construction project.

In an embodiment, the subject matter of the present disclosure discloses a method for creating a project manifest in a computing environment. The method comprises receiving a request related to a project, the project is at least one of a construction project and a manufacturing project, determining one or more project objectives related to the request, and determining a set of constraints for the project. The set of constraints may be derived at least through a knowledge repository that includes one or more of parameters related to the project and a data feed from a plurality of data sources associated with the project. The method further comprises correlating the determined set of constraints with the one or more project objectives, evaluating the correlated set of constraints and the one or more project objectives to generate an optimized model, and creating a project manifest based on the optimized model for executing the project.

In an embodiment of the present disclosure, the method may further include determining the one or more project objectives from at least one of: a time objective, a cost objective, a quality objective, a sustainability objective, an efficiency objective, and a health objective associated with the project.

In an embodiment of the present disclosure, the method further includes determining the parameters related to the project based on at least one of: a historical data related to the project, an industry data associated with the project, an execution data for the project, and a forecast data associated with the project.

In an embodiment of the present disclosure, the method further includes applying one or more of deep-learning, Artificial Intelligence (AI), and Machine Learning (ML) processes to generate the optimized model.

In an embodiment of the present disclosure, the method further includes determining the set of constraints, the set of constraints including at least one of: pre-existing manufacturing data sets, supplier data sets, material data sets, geolocation data sets, and environmental data sets.

In an embodiment of the present disclosure, the method further includes analyzing real-time data and user modification associated with the set of constraints for achieving custom project objectives, determining an impact of the analyzed data on the one or more project objectives, and generating an updated project manifest based on the determined impact.

In an embodiment of the present disclosure, the method further includes creating the project manifest that includes the optimized model covering time, cost, and schedule aspects from at least one of project, manpower, equipment, source, material, logistics, and processes.

In an embodiment of the present disclosure, the method further includes monitoring a production efficiency associated with the project and providing one or more of a causality data and a remedial data associated with the production efficiency.

In an embodiment of the present disclosure, the method further includes receiving a bidding request for the request related to the project from one or more bidders who intend to work on the project, and providing a set of recommendations to the one or more bidders based on the generated optimized model associated with the project. In an embodiment, providing the set of recommendations includes providing at least one of: a cost forecast, a project manifest associated with the project, a time forecast, and materials supplier information. The method may further include receiving bids related to the project from the one or more bidders based on the set of recommendations, arranging the received bids based on the one or more project objectives, and providing the arranged bids related to the project on a digital marketplace interface.

In an embodiment, the subject matter of the present disclosure discloses a computing system for creating a project manifest in a computing environment. The computing system comprises one or more computer systems comprising one or more hardware processors and storage media. The computing system also comprises instructions, stored in the storage media, implementing a factory interface module, which when executed by the computing system, causes the computing system to: receive a request related to a project, the project is at least one of a construction project and a manufacturing project, determine one or more project objectives related to the request, determine a set of constraints for the project, the set of constraints are derived at least through a knowledge repository that includes one or more of parameters related to the project and a data feed from a plurality of data sources associated with the project, correlate the determined set of constraints with the one or more project objectives, evaluate the correlated set of constraints and the one or more project objectives to generate an optimized model, and create a project manifest based on the optimized model for executing the project.

In an embodiment of the present disclosure, the system further includes instructions, stored in the storage media, implementing an optimizer module for achieving custom project objectives, which when executed by the computing system, causes the computing systemto: analyze real-time data and user modification associated with the set of constraints, determine an impact of the analyzed data on the one or more project objectives, and generate an updated project manifest based on the determined impact.

In an embodiment of the present disclosure, the system further includes instructions, stored in the storage media, implementing a monitor production efficiencies module, which when executed by the computing system, causes the computing system to: monitor production efficiency associated with the project, and provide one or more of a causality data and a remedial data associated with the production efficiency.

In an embodiment of the present disclosure, the factory interface module, when executed by the computing system, further causes the computing system to create the project manifest that includes the optimized model covering time, cost, and schedule aspects from at least one of project, manpower, equipment, source, material, logistics, and processes.

In an embodiment of the present disclosure, the system further includes instructions, stored in the storage media, implementing a marketplace debut module, which when executed by the computing system, causes the computing system to: receive a bidding request for the request related to the project from one or more bidders who intend to work on the project, and provide a set of recommendations to the one or more bidders based on the generated optimized model associated with the project.

In an embodiment of the present disclosure, the system further includes instructions, stored in the storage media, implementing a bid manager, which when executed by the computing system, causes the computing system to: receive bids related to the project from the one or more bidders based on the set of recommendations provided by the marketplace debut module, arrange the received bids based on the one or more project objectives, and provide the arranged bids related to the project on a digital marketplace interface.

In an embodiment, the subject matter of the present disclosure may relate to a non-transitory computer-readable storage medium, having stored thereon a computer-executable program which, when executed by at least one processor, causes the at least one processor to: receive a request related to a project, the project is at least one of a construction project and a manufacturing project, determine one or more project objectives related to the request, determine a set of constraints for the project, the set of constraints are derived at least through a knowledge repository that includes one or more of parameters related to the project and a data feed from a plurality of data sources associated with the project, correlate the determined set of constraints with the one or more project objectives, evaluate the correlated set of constraints and the one or more project objectives to generate an optimized model, and create a project manifest based on the optimized model for executing the project.

In an embodiment of the present disclosure, the computer-executable program further causes the at least one processor to: analyze real-time data and user modification associated with the set of constraints for achieving a custom project objective, determine an impact of the analyzed data on the one or more project objectives, and generate an updated project manifest based on the determined impact.

In an embodiment of the present disclosure, the computer-executable program further causes the at least one processor to: monitor a production efficiency associated with the project, and provide one or more of a causality data and a remedial data associated with the production efficiency.

In an embodiment of the present disclosure, the computer-executable program further causes the at least one processor to: receive a bidding request for the request related to the project from one or more bidders who intend to work on the project, and provide a set of recommendations to the one or more bidders based on the generated optimized model associated with the project.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which will be further described below.

### BRIEF DESCRIPTION OF THE DRAWINGS

Further advantages of the invention will become apparent by reference to the detailed description of preferred embodiments when considered in conjunction with the drawings:

FIG. 1 illustrates an exemplary network architecture, according to an embodiment.

FIG. 2A illustrates an exemplary computing system to design, manufacture, and customize construction artefacts or assemblies for a construction project, according to an embodiment.

FIG. 2B is a schematic diagram illustrating an exemplary project manifest, according to an embodiment.

FIG. 2C is a schematic diagram illustrating an overview of a digital marketplace, according to an embodiment.

FIG. 3 is a schematic diagram illustrating an overview of use of a File to Factory (F2F) service, according to an embodiment.

FIG. 4 is a schematic diagram illustrating example inputs and outputs to a customizable digital product (CDP), according to an embodiment.

FIG. 5 is a schematic diagram illustrating example inputs to a knowledge repository, according to an embodiment.

FIG. 6 is a schematic diagram illustrating an integration of multiple customizable digital products (CDPs) from buildings through associated material suppliers, according to an embodiment.

FIG. 7 is an exemplary flowchart illustrating method steps of creating a project manifest for a project, according to an embodiment.

FIG. 8 is another flowchart illustrating method steps of creating a project manifest for a project, according to an embodiment.

FIG. 9 is an exemplary flowchart illustrating method steps of managing bidding, and providing support and maintenance related to a construction and/or manufacturing project, according to an embodiment.

### DETAILED DESCRIPTION

The following detailed description is presented to enable a person skilled in the art to make and use the disclosure. For purposes of explanation, specific details are set forth to provide a thorough understanding of the present disclosure. However, it will be apparent to one skilled in the art that these specific details are not required to practice the disclosure. Descriptions of specific applications are provided only as representative examples. Various modifications to the preferred embodiments will be readily apparent to one skilled in the art, and the general principles defined herein may be applied to other embodiments and applications without departing from the scope of the disclosure. The present disclosure is not intended to be limited to the embodiments shown but is to be accorded the widest possible scope consistent with the principles and features disclosed herein.

Embodiments are described herein in sections according to the following outline:

| | | |
|---|---|---|
| 1.0 | | GENERAL OVERVIEW |
| 2.0 | | STRUCTURAL OVERVIEW |
| 3.0 | | FUNTIONAL OVERVIEW |
| | 3.1 | CUSTOMIZABLE DIGITAL PRODUCT SUBSYSTEM |
| | 3.2 | FACTORY INTERFACE & DELIVERY LOGISTICS SUBSYSTEM |
| | 3.3 | MARKETPLACE SUBSYSTEM |
| 4.0 | | FILE TO FACTORY SERVICE |
| 5.0 | | PROCEDURAL OVERVIEW |
| 6.0 | | EXAMPLE INTENT-BASED DESIGN AND COMPUATIONAL SIMULATION FLOW |
| 7.0 | | OTHER ASPECTS OF DISCLOSURE |

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown but is to be accorded the widest possible scope consistent with the principles and features disclosed herein.

### 1.0 General Overview

Planning any construction related activity usually involves multiple processes and implementations including generation and management of diagrammatic and digital representations of a part or whole of construction designs, associated works, and several algorithms driven planning and management of human, equipment, and material resources associated with undertaking the construction in a real-world environment. The process involves creation of digital twins (e.g., virtual representations rendered in a graphical user interface) of a construction model, and simulation of various processes and events of a construction project. For example, these aspects may include a construction schedule, work packs, work orders, sequence and timing of materials needed, procurement schedule, timing and source for procurement, etc. Additional aspects including labor, duration, dependence on ecosystem factors, topology of the construction area, weather patterns, and surrounding traffic are also considered during aforesaid creation of virtual representations. Furthermore, cost parameters, timelines, understanding and adherence to regulatory processes, and environmental factors, also play an important role in the planning.

Techniques described herein are directed to a method for creating a project manifest in a computing environment. The method comprises receiving a request related to a project, the project is at least one of a construction project and a manufacturing project, determining one or more project objectives related to the request, and determining a set of constraints for the project. The set of constraints may be derived at least through a knowledge repository that includes one or more of parameters related to the project and a data feed from a plurality of data sources associated with the project. The method further comprises correlating the determined set of constraints with the one or more project objectives, evaluating the correlated set of constraints and the one or more project objectives to generate an optimized model, and creating a project manifest based on the optimized model for executing the.

The present disclosure aims to make management of manufacturing and/or construction projects simple. This is achieved by improving and making a manufacturing and/or a construction cycle of a project more efficient, for example, by creating a project manifest providing an optimized model for executing the project, such that, the optimized model is created using AI/ML techniques by evaluating a variety of data sources associated with the project.

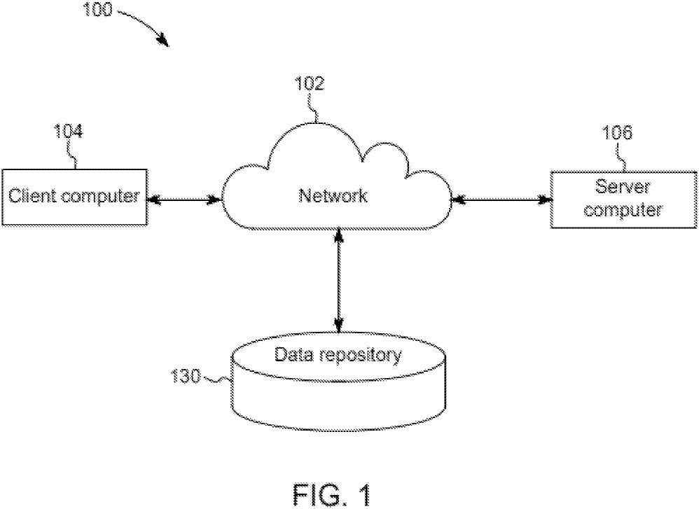

Various embodiments of the methods and systems are described in more detail with reference to FIGS. 1-9. Other embodiments, aspects, and features will become apparent from the remainder of the disclosure.

Certain terms and phrases have been used throughout the disclosure and will have the following meanings in the context of the ongoing disclosure.

The term “manufacturing project” and/or “construction project”, as used herein and sometimes just referred to as a “project”, may refer to the organized process of constructing, renovating, refurbishing, etc., a building, structure, or infrastructure. The project process may typically start with an overarching requirement which is developed through the creation of brief feasibility studies, option studies, design, financing, and construction.

The term “Customizable Digital Product (CDP)”, as used herein, may refer to a parametric component that has been developed to have restrictions and parameters of exactly what is achievable with an associated supply chain team. The term “product” may be used interchangeably with the word “item” without departing from the scope of the disclosure.

The term “Building Information Model (BIM)”, as used herein, may refer to an entity and process supported by various tools, technologies, and contracts involving the generation and management of digital representations of physical and functional characteristics of a building structure. BIMs may be computer generated files (often but not always in proprietary formats and containing proprietary data) which may be extracted, exchanged, or networked to support decision-making regarding a built asset. Further, BIM software may be used by individuals, businesses, and government agencies who plan, design, construct, operate, and maintain buildings and diverse physical infrastructures, such as water, refuse, electricity, gas, communication utilities, roads, railways, bridges, ports, and tunnels. BIM data may include dimensional data (e.g., 2 to 6 or more dimensions) of a building component, spatial information, material information, sectional views, elevation and aerial views, floor plans, foundations, and the like. Dimensional data of a building component may be included as part of a BIM model.

The term “construction artefacts”, as used herein, may refer to objects produced or shaped by human craft, and may be related to construction industry. The term “construction artefacts” may be used interchangeably with the term “construction assemblies” or the term “construction modules” without departing from the scope of the disclosure. Example construction artefacts are building components such as walls, trusses, fixtures, windows, plumbing, floor components, roof components, etc.

The term “database”, as used herein, may refer to an organized collection of structured information, or data, typically stored electronically in a computer system. The term “database” may be used interchangeably with the word “library” without departing from the scope of the disclosure.

The term “supply chain team”, as used herein, may refer to the people and functions required to transform the design into a physical product. A non-limiting list of functions include manufacturers, assemblers, purchasers, raw material suppliers, and cost estimators.

A “network” may refer to a series of nodes or network elements that are interconnected via communication paths. In an example, the network may include any number of software and/or hardware elements coupled to each other to establish the communication paths and route data/traffic via the established communication paths. In accordance with the embodiments of the present disclosure, the network may include, but are not limited to, the Internet, a local area network (LAN), a wide area network (WAN), an Internet of things (IoT) network, and/or a wireless network. Further, in accordance with the embodiments of the present disclosure, the network may comprise, but is not limited to, copper transmission cables, optical transmission fires, wireless transmission, routers, firewalls, switches, gateway computers, and/or edge servers.

A “device” may refer to an apparatus using electrical, mechanical, thermal, etc., power and having several parts, each with a definite function and together performing a particular task. In accordance with the embodiments of the present disclosure, a device may include, but is not limited to, one or more IoT devices. Further, one or more IoT devices may be related, but are not limited to, connected appliances, smart home security systems, autonomous farming equipment, wearable health monitors, smart factory equipment, wireless inventory trackers, ultra-high speed wireless internet, biometric cybersecurity scanners, and shipping container and logistics tracking.

A “processor” may include a module that performs the methods described in accordance with the embodiments of the present disclosure. The module of the processor may be programmed into the integrated circuits of the processor, or loaded in memory, storage device, or network, or combinations thereof.

“Machine learning” may refer to as a study of computer algorithms that may improve automatically through experience and using data. Machine learning algorithms build a model based at least on sample data, known as “training data,” to make predictions or decisions without being explicitly programmed to do so. Machine learning algorithms are used in a wide variety of applications, such as in medicine, email filtering, speech recognition, and computer vision, where it is difficult or unfeasible to develop conventional algorithms to perform the needed tasks.

In machine learning, a common task is the study and construction of algorithms that can learn from and make predictions on data. Such algorithms function by making data-driven predictions or decisions, through building a mathematical model from input data. These input data used to build the model are usually divided in multiple data sets. Three data sets are commonly used in various stages of the creation of the model: training, validation, and test sets. The model is initially fit on a “training data set,” which is a set of examples used to fit the parameters of the model. The model is trained on the training data set using a supervised learning method. The model is run with the training data set and produces a result, which is then compared with a target, for each input vector in the training data set. Based at least on the result of the comparison and the specific learning algorithm being used, the parameters of the model are adjusted. The model fitting can include both variable selection and parameter estimation.

Successively, the fitted model is used to predict the responses for the observations in a second data set called the “validation data set.” The validation data set provides an unbiased evaluation of a model fit on the training data set while tuning the model’s hyperparameters. Finally, the “test data set” is a data set used to provide an unbiased evaluation of a final model fit on the training data set.

Machine learning models disclosed herein may include appropriate classifiers and ML methodologies. Some of the ML algorithms include (1) Multilayer Perceptron, Support Vector Machines, Bayesian learning, K-Nearest Neighbor, or Naive Bayes as part of supervised learning, (2) Generative Adversarial Networks as part of Semi Supervised learning, (3) Unsupervised learning utilizing Autoencoders, Gaussian Mixture and K-means clustering, and (4) Reinforcement learning (e.g., using a 0-learning algorithm, using temporal difference learning), and other suitable learning styles. Knowledge transfer is applied, and, for small footprint devices, Binarization and Quantization of models is performed for resource optimization for ML models. Each module of the plurality of ML models can implement one or more of: a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomize 3, C4.5, chi-squared automatic interaction detection, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, a linear discriminate analysis, etc.), a clustering method (e.g., k-means clustering, expectation maximization, etc.), an associated rule learning algorithm (e.g., an Eclat algorithm, etc.), an artificial neural network model (e.g., a Perceptron method, a back-propagation method, a self-organizing map method, a learning vector quantization method, etc.), a deep learning algorithm (e.g., a restricted Boltzmann machine, a deep belief network method, a convolution network method, a stacked auto-encoder method, etc.), and a dimensionality reduction method (e.g., principal component analysis, partial least squares regression, multidimensional scaling, etc.). Each processing portion of system 100 of FIG. 1 can additionally leverage: a probabilistic, heuristic, deterministic or other suitable methodologies for computational guidance, recommendations, machine learning or combination thereof. However, any suitable machine learning approach can otherwise be incorporated in the system. Further, any suitable model (e.g., machine learning, non-machine learning, etc.) can be used in the system of the present disclosure.

The embodiments of the present disclosure are described in more detail with reference to FIGS. 1-9.

### 2.0 Structural Overview

FIG. 1 illustrates an example networked computer system 100 with which various embodiments of the present disclosure may be implemented. FIG. 1 is shown in simplified, schematic format for purposes of illustrating a clear example and other embodiments may include more, fewer, or different elements. FIG. 1 and the other drawing figures, and all the description and claims in this disclosure are intended to present, disclose and claim a technical system and technical methods. The technical system and methods as disclosed includes specially programmed computers, using a special-purpose distributed computer system design and instructions that are programmed to execute the functions that are described. These elements execute to provide a practical application of computing technology to the problem of optimizing schedule, resource allocation, and work sequencing for planning and execution. In this manner, the current disclosure presents a technical solution to a technical problem, and any interpretation of the disclosure or claims to cover any judicial exception to patent eligibility, such as an abstract idea, mental process, method of organizing human activity or mathematical algorithm, has no support in this disclosure and is erroneous.

In some embodiments, the networked computer system 100 may include a client computer(s) 104, a server computer 106, and a data repository(ies) 130, which are communicatively coupled directly or indirectly via a network 102. In an embodiment, the server computer 106 broadly represents one or more computers, such as one or more desktop computers, server computers, a server farm, a cloud computing platform, a parallel computer, virtual computing instances in public or private datacenters, and/or instances of a server-based application. The server computer 106 may be accessible over the network 102 by the client computer 104, for example, to request a schedule or a resource recommendation and to make a query. The client computer 104 may include a desktop computer, laptop computer, tablet computer, smartphone, or any other type of computing device that allows access to the server computer 106. The elements in FIG. 1 are intended to represent one workable embodiment but are not intended to constrain or limit the number of elements that could be used in other embodiments.

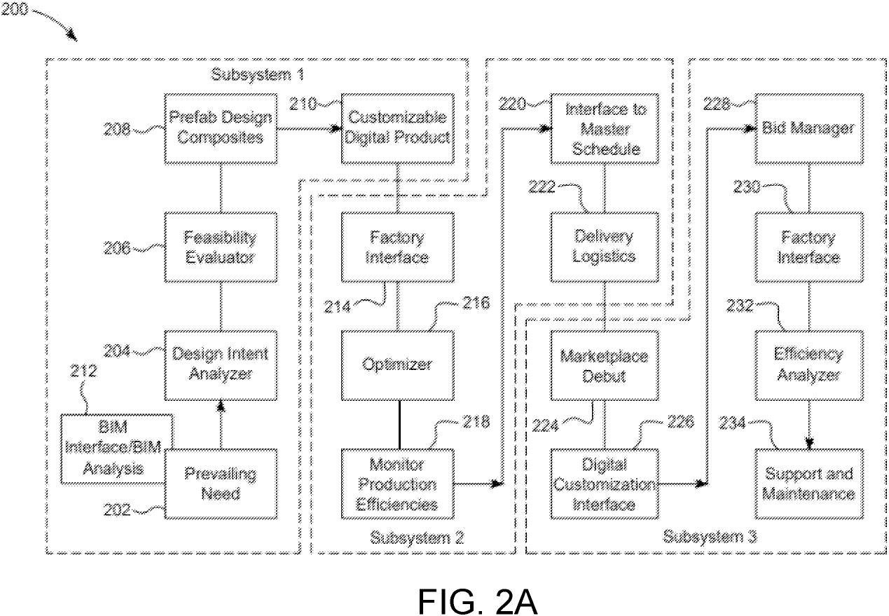

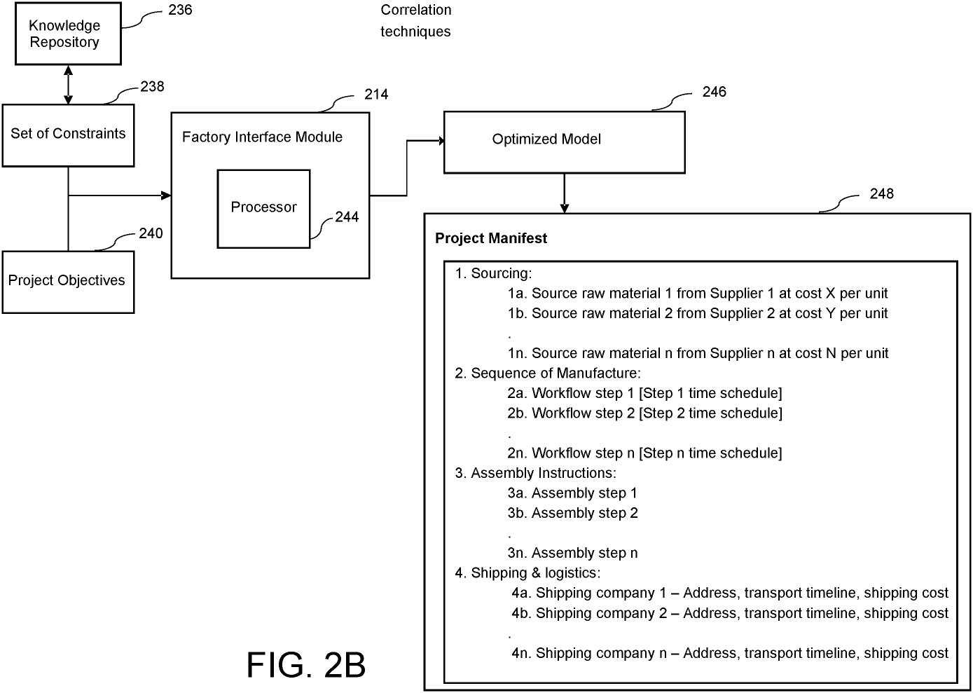

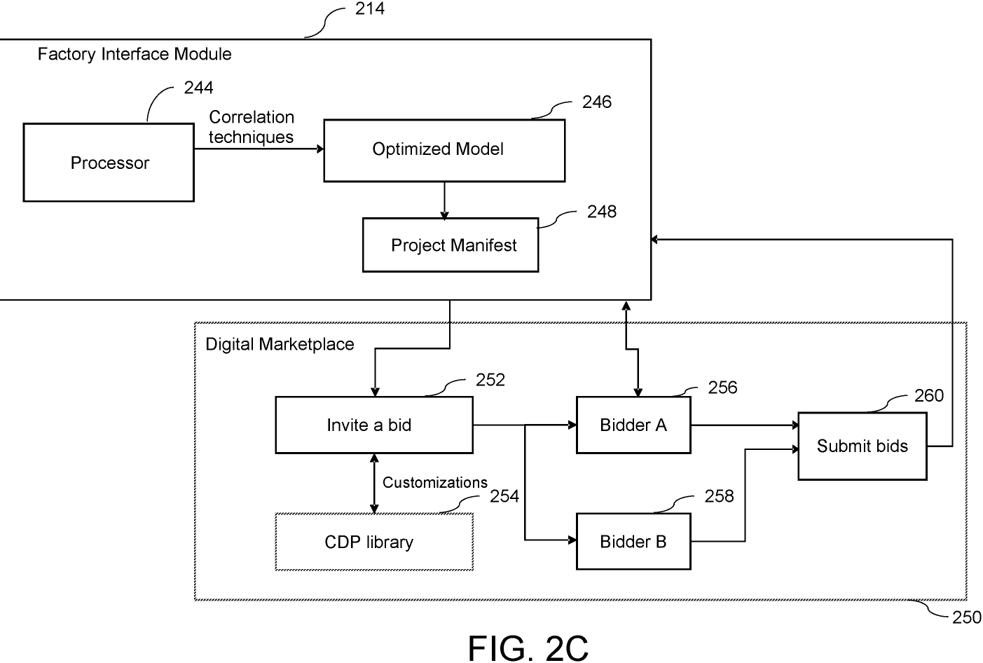

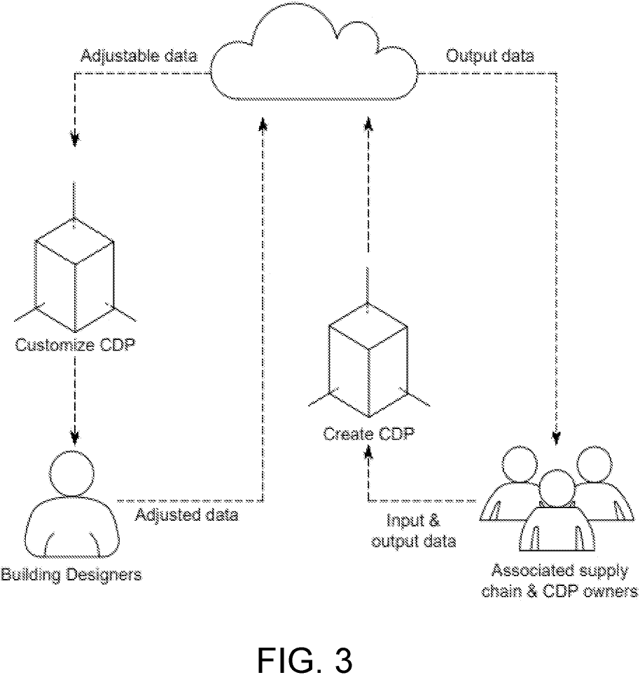

The server computer 106 may include one or more computer programs or sequences of program instructions in organization. Such organization implements artificial intelligence / machine learning algorithms to generate data pertaining to various requirements, such as design consideration factors in a construction project, controlling functions, notifying functions, monitoring functions, and modifying functions. A set of diverse or even mutually exclusive programs or sequences of instructions are organized together to implement diverse functions to generate data associated with design consideration factors. Such set may include Subsystem 1, Subsystem 2, and Subsystem 3, as illustrated in FIG. 2. In some embodiments, in keeping with sound software engineering principles of modularity and separation of functions, the Subsystem 1, Subsystem 2, and Subsystem 3 are each implemented as a logically separate program, process, or library. They may also be implemented as hardware modules or a combination of both hardware and software modules without limitation.

In an embodiment, the networked computer system 100 may be an AI system and may include the client computer 104, the server computer 106, and the data repository 130 that are communicatively coupled to each other via the network 102. An example AI-based system is described in U.S. Provisional Application No. 63/280,881, filed Nov. 18, 2021, and titled “Method and System for Multi-Factor Optimization of Schedules and Resource Recommendations for Smart Construction Utilizing Human and Machine Cognition,” U.S. Pat. Application No. 17/683,858, filed Mar. 1, 2022, and titled “Intelligence Driven Method and System for Multi-Factor optimization of Schedules and Resource Recommendations for Smart Construction,” U.S. Provisional Application No. 63/324,715, filed Mar. 29, 2022, and titled “System and methods for intent-based factorization and computational simulation,” U.S. Patent Application No. 17/894,418, filed Aug. 24, 2022, and titled “System and Method for Computational Simulation and Augmented/Virtual Reality in a Construction Environment,”, and U.S. Pat. Application No. 18/107,653, filed Feb. 9, 2023, and titled “System and Method for Manufacture and Customization of Construction Assemblies in a Computing Environment,” the entire contents of which are hereby incorporated by reference for all purposes as if fully set forth herein. In an embodiment, one or more components of the server computer 106 may include a processor configured to execute program instructions stored in a non-transitory computer readable medium.

Computer executable instructions described herein may be in machine executable code in the instruction set of a CPU and may be compiled based upon source code written in Python, JAVA, C, C++, OBJECTIVE-C, or any other human-readable programming language or environment, alone or in combination with scripts in JAVASCRIPT, other scripting languages and other programming source text. In another embodiment, the programmed instructions may also represent one or more files or projects of source code that are digitally stored in a mass storage device such as non-volatile RAM or disk storage, in the systems of FIG. 1 or a separate repository system, which when compiled or interpreted cause generation of executable instructions that in turn upon execution cause the computer to perform the functions or operations that are described herein with reference to those instructions. In other words, the figure may represent the way programmers or software developers organize and arrange source code for later compilation into an executable, or interpretation into bytecode or the equivalent, for execution by the server computer 106.

The server computer 106 may be communicatively coupled to the data repository 130. The data repository 130 includes a prefab database and a design database. In an embodiment, the prefab database may store data relating to existing factory prefabricated construction artefacts previously generated, and the design database may store data relating to design elements. The data repository 130 may include additional databases that may be used by the server computer 106. Such databases are described in the above-mentioned applications that are incorporated by reference for all purposes as if fully set forth herein. Each database may be implemented using memory, e.g., RAM, EEPROM, flash memory, hard disk drives, optical disc drives, solid state memory, or any type of memory suitable for database storage.

### 3.0 Functional Overview

FIG. 2A illustrates an exemplary computing system 200 to design, manufacture, and customize construction artefacts (also referred to as construction assemblies or construction modules) for a construction project, according to an embodiment. The computing system 200 may be referred herein to as a product-simulation system. In an embodiment, the server computer 106 is similarly configured as the computing system 200. As illustrated in FIG. 2, the computing system 200 may include, but is not limited to, a CDP Subsystem (indicated as Subsystem 1 in FIG. 2), a Factory Interface and Delivery Logistics Subsystem (indicated as Subsystem 2 in FIG. 2), and a Marketplace Subsystem (indicated Subsystem 3 in FIG. 2). The subsystems of the computing system 200 interoperate in an unconventional manner, depending on use requirements, to improve and make a construction cycle of a construction project more efficient.

### 3.1 Customizable Digital Product Subsystem

In an embodiment, the CDP Subsystem may include, but is not limited to, a Prevailing Needs Analyzer module 202, a Design Intent Analyzer module 204, a Feasibility Evaluator module 206, a Prefab Design Composites module 208, and a CDP module 210. Each of these modules may implement one or more AI/ML techniques described herein.

In an embodiment, the Prevailing Needs Analyzer module 202 may analyze BIM data including drawings of buildings/floor plans associated with one or more construction projects. An example drawing may be a two-dimensional architectural or a construction drawing, or a three-dimensional architectural or a construction drawing provided by the BIM data. The BIM data, as input data, may be received via a BIM interface 212 of Subsystem 1. For example, the BIM interface 212 may have the ability to consume/receive multiple BIM models and multiple versions of the BIM models and retain the context for downstream processing. The BIM interface 212 may receive input BIM data from user input and/or the data repository 130 of FIG. 1.

In an embodiment, the Prevailing Needs Analyzer module 202 may perform analysis on one or more of: floor plans of the one or more construction projects related to the buildings/floor plans, a construction schedule for the one or more construction projects, a list of associated tasks in business process workflow for the one or more construction projects, a list of dependencies associated with the one or more construction projects, material requirements for the one or more construction projects, and labor needs for the one or more construction projects. In some embodiments, the Prevailing Needs Analyzer module 202 may perform the analysis using one or more AI and/or ML algorithms. Furthermore, the Prevailing Needs Analyzer module 202 may compute, from the input BIM data, a plurality of custom construction artefacts for the one or more construction projects, and may further compute time, material, and labor costs for on-site manufacture and assembly of materials related to the one or more construction projects. In an embodiment, the Prevailing Needs Analyzer module 202, when computing the plurality of custom construction artefacts, may refer to system objectives and/or environmental considerations - for example, the system objective may be to finish the one or more construction projects within certain timelines. Other system objectives may also be possible. Further, environmental considerations may include, but not limited to, if the structure to be built over a shallow waterway, withstand sub-zero temperatures, high humidity, heavy floor traffic, heavy vehicle traffic, carbon limits and the like. Example construction artefacts are building components such as walls, trusses, fixtures, windows, plumbing, floor components, roof components, etc.

Additionally, the Prevailing Needs Analyzer module 202 may determine whether one or more custom construction artefacts of the plurality of custom construction artefacts for the one or more construction projects are to be prefabricated and may further evaluate if prefabrication of the one or more custom construction artefacts for the one or more construction projects will be beneficial (in terms of time and cost, as an example). AI and ML may be used by the Prevailing Needs Analyzer module 202 to know what the customization (of the one or more construction artefacts) entails in real time (using one or more training data sets related to the one or more construction artefacts) and how much it would cost, the project delivery times, and exactly how many quantities, sizes, and lead times of the material (for the one or more construction artefacts) may be required. Further, the Prevailing Needs Analyzer module 202 may comprehend the dynamic variations in factors impacting construction of one or more custom construction artefacts and may provide meaningful insights or actionable guidance to improve ways of designing and manufacturing the one or more custom construction artefacts. In some embodiments, the Prevailing Needs Analyzer module 202 may perform the evaluation using one or more computational algorithms including but not limited to AI and/or ML algorithms, Bruteforce algorithms, Greedy algorithms, Backtracking algorithms, and/or Recursive algorithms. As an example, if offsite manufacturing or procurement of certain construction artefacts is a viable option in terms of time, quality, and cost, models of, the one or more computational algorithms of the Prevailing Needs Analyzer module 202 may indicate a need for factory prefabricated custom construction artefacts. In some embodiments, the one or more computational algorithms (including at least the AI and/or ML algorithms) may be designed to take into consideration, factors (that may impact the construction schedule and design) that are near impractical to predict, plan, and accommodate until the factors come to pass or are likely to come to pass with some degree of certainty. In some embodiments, the computing system 200 identifies elements of a custom construction artefact that may be prefabricated.

Additionally, the Prevailing Needs Analyzer module 202 may check the prefab library to see whether any of the factory prefabricated custom construction artefacts already exist in the prefab library. For example, in response to determining that the one or more custom construction artefacts for the one or more construction projects are to be prefabricated, the Prevailing Needs Analyzer module 202 may check the prefab library to determine whether one or more existing construction artefacts similar to the one or more custom construction artefacts for the one or more construction projects exist in the prefab library. In an embodiment, the one or more existing construction artefacts are similar to the one or more custom construction artefacts for the one or more construction projects existing in the prefab library at least when they both have a number of properties in common and/or when they both have a number of characteristics in common. Examples of properties may include, but not limited to, one or more of physical properties, mechanical properties, chemical properties, electrical properties, magnetic properties, and thermal properties related to the construction artefacts. Examples of the characteristics may include, but not limited to, one or more of abundance in nature, cost, easy to make and repair, age (wear and tear), shape, dimensions, and temperature in different seasons.

Additionally, the Prevailing Needs Analyzer module 202 may recommend one or more existing construction artefacts, different from the one or more custom construction artefacts to be prefabricated, in response to determining that no existing construction artefacts like the one or more custom construction artefacts of the one or more construction projects, exist in the prefab library. In an example, if none of the existing construction artefacts are like the one or more custom construction artefacts of the one or more construction projects, the computing system 200 may recommend one or more existing prefabricated artefacts that are comparable and accommodate for the identification of the nearest fit for the present requirements. In an embodiment, identification of the nearest fit for the present requirements may at least include identifying one or more existing construction artefacts that are comparable (e.g., could be considered similar, by a predetermined amount with respect to one or more properties (as discussed above) and/or one or more characteristics (as discussed above), to the one or more custom construction artefacts). In some embodiments, the nearest fit can refer to a recommendation that tries to factor in the prevailing needs, user intents, spatial and geographic considerations and tries to look into a system knowledge store for comparable artifact/information to be present to include in the recommendation. The nearest fit may then be presented to a user for customization such that designs of construction artefacts may be reused. In some embodiments, one or more AI and/or ML algorithms may be used to identify the nearest fit for the present requirements.

Additionally, the Prevailing Needs Analyzer module 202 may design reusable construction artefacts. In an embodiment, the computing system 200 may auto compose designs of the reusable construction artefacts based at least on preset specifications. In an example, for a window panel having dimensions 4 ft by 6 ft with steel rails, the computing system 200 may present few prefabricated designs and may custom make few designs based at least on the BIM data. Further, the Prevailing Needs Analyzer module 202 may not only present few prefab designs but also indicate how an assembly of the window panel may be performed from a configuration perspective of a construction process. Further, in an embodiment, the preset specifications may be related, but not limited to, one or more of nature, cost, easy to make and repair, age (wear and tear), shape, dimensions, and temperature in different seasons, of the construction artefacts.

In an embodiment, the Prevailing Needs Analyzer module 202 may recommend a subset of tasks related to the one or more construction projects be routed or executed offsite and brought into construction site at specific points in time during construction phase of the one or more construction projects. Further, the Prevailing Needs Analyzer module 202 may recommend an optimized construction schedule for a construction project based at least on the analyzed data.

In summary, once the Prevailing Needs Analyzer module 202 analyzes its input data, the computing system 200 may introspect the data and output a set of tasks that optimize construction schedule for the one or more construction projects, business process workflows to manage the one or more construction projects, etc. As an example, if a construction project involves window panels (there may be many window panels in a large commercial building), the computing system 200 may recommend that instead of getting raw material and then assembling the window panels with labor onsite, it may be preferable to prefabricate the requisite window panels offsite and thereafter transport them onsite. Further, even if the prevailing assembled window panels are absent, the computing system 200 may additionally recommend a way to fabricate such window panels and cater to the construction project needs.

In an embodiment, the Design Intent Analyzer module 204 may evaluate human and physical intent of arriving at a physical design of the plurality of custom construction artefacts for the one or more construction projects. For example, the Design Intent Analyzer module 204 may evaluate that the intent may be to save time and costs or otherwise to reduce a number of contractors onsite (and thereby reduce work-place liability). In an embodiment, the Design Intent Analyzer module 204 may perform intent analysis to determine an intent or a set of objectives for the one or more custom construction artefacts that are to be prefabricated. Further, in an alternative or additional embodiment, the Design Intent Analyzer module 204 may perform intent analysis, to determine an intent or a set of objectives for the one or more custom construction artefacts that are to be prefabricated, in response to a query (input) from a user. Objective and intent may be related and usually are to be directionally aligned. As an illustration, an objective may be to finish the project on a specific timeline, and intent in this case may be to enable to accommodate a window frame of certain dimension. This can be design intent and, in which case, more than one option will exist to support the design intent.

Further, the Design Intent Analyzer module 204 may translate the intent for the one or more custom construction artefacts to designs for the one or more custom construction artefacts by using the design library. In particular, once the intent is determined, for a particular custom construction artefact, or a task, or a business process workflow, etc., the computing system 200 may query the design library and verify if the intent may be correlated to design element(s) already available in the design library, and output a set of recommendations for optimizing designs of the custom construction artefacts to meet a criteria defined by the intent or the set of objectives. Design elements may be, for example, steel window frames of certain design, bathroom pods of specific dimension and so on.

Furthermore, the Design Intent Analyzer module 204 may provide human interface facilitation for designing the one or more custom construction artefacts. For example, a user interface (e.g., a graphical user interface) may be provided on a client device 104 to enable a user to provide inputs for optimal designs for manufacturing the one or more custom construction artefacts that are to be prefabricated. Further, a visual display may be provided to the user (e.g., rendered on a client device 104) to enable physical product simulation of at least the one or more custom construction artefacts that are to be prefabricated. The physical product simulation may enable the user to visualize a physical product that is taking shape. Further, providing the visual display to the user may further enable visual modifications of the physical product that is being configured. In an embodiment, the Design Intent Analyzer module 204 may operate as at least a part of a rendering unit enabling simulation of at least the one or more custom construction artefacts based on the determination of the intent for the one or more custom construction artefacts or at least one objective to render a digital representation of the physical product in the user interface (e.g., a graphical user interface). It is noted that the rendering unit may also include other modules described herein.

Additionally, the Design Intent Analyzer module 204 may compute optimal designs for the one or more custom construction artefacts to meet the set objectives. In an embodiment, optimal designs for manufacturing the one or more custom construction artefacts that are to be prefabricated may be computed based at least on one or more of: existing construction artefacts of the prefab library, physical elements associated with the one or more construction projects, nature of construction of the one or more construction projects, geography at the one or more construction projects, and local topology related to the one or more construction projects. An optimal design, for example, may factor in physical elements of a custom construction artefact, a topology of an area where the custom construction artefact is going to be installed, a purpose of the custom construction artefact (e.g., is it function or aesthetic), and recommendations, for example, may include a material to be used to build/fabricate the custom construction artefact, etc. Further, a set of optimal design parameters may be outputted for the computed optimal designs to meet assembly requirements of the one or more custom construction artefacts that are to be prefabricated. In some embodiments, one or more AI and/or ML algorithms may be used to compute optimal designs for the one or more custom construction artefacts to meet the set objectives.

In an example, the Design Intent Analyzer module 204 may be configured to derive a user specific intent from the natural language (NL) based content from the provided user query (input) and prevailing factors such as timeline of the construction project. In some examples, the user query (input) may be provided via the BIM Interface 212. Further, in some examples, the user query (input) may be provided to the Design Intent Analyzer module 204 prior to analyzing the BIM data. Further, in some examples, the user query (input) may be related to (i) Providing optioneering for vertical hold structure of the construction project to fit in 50 by 50 inch substructure (of the construction project): Can the vertical hold structure be sliced into 3 vertical hold outs? What if the vertical hold structure is split up horizontally? and/or (ii) Generating a shallow waterway optimal design for an overview bridge: Overview a bridge waterway structure to stand corrosive influences? What possible outcomes that may be obtained if a girder is hanged from a third floor of the structure? Can an angled bracket tied to the structure at higher elevation make the structure withstand speeds of 10 mph (as an example), Can an elevation bracket integrated with the structure make the structure withstand wind gust upwards 10 mph? In some examples, the user specific intent may be derived at least by inferring the construction project demographics - location, temperature, topography, soil, elevation, foot traffic, current design if present and more and by correlating the inference to the user query (input). In some examples, the user query whether spoken or written may be internalized as written natural language queries and are interpreted by tokenizing operations, i.e., breaking user input into words using tokenization technique of space characters. Thereafter, as a part of normalization operation, non-standard words are converted to standard words. This may be achieved using text simplification techniques or other predefined techniques. In some examples, the normalized text obtained may not be merely phrasal. In such cases, the normalized text may include contextual connotations and the combination of all of that is what the Design Intent Analyzer module 204 will translate into the appropriate machine relatable queries. An intent may then be obtained from the normalized text through various techniques such as unsupervised learning, dimensionality reduction or clustering. Such techniques may be technically referred by a NMF (Non-negative Matrix Factorization), LSA (Latent Semantic Analysis), LDA (Latent Dirichlet Allocation) etc. In some embodiments, one or more AI and/or ML algorithms may be used to derive the user specific intent and/or the objective(s) associated with one or more construction artefacts.

In an embodiment, the Feasibility Evaluator module 206 may evaluate the feasibility of building a physical product assembly that includes the plurality of custom construction artefacts. In an embodiment, the Feasibility Evaluator module 206 may evaluate feasibility of dissembling, shipping, and reassembling the one or more custom construction artefacts that are to be prefabricated and brought to one or more construction sites of the one or more construction projects. In an embodiment, the Feasibility Evaluator module 206 may be provided inputs on the feasibility of dissembling, shipping, and reassembling the one or more custom construction artefacts, from an external information source. Further, in an embodiment, the Feasibility Evaluator module 206 may be provided with data relating to cost objectives related to the feasibility of building the physical product assembly. In such a scenario, the Feasibility Evaluator module 206 factors in the provided cost objectives when evaluating the feasibility of building the physical product assembly. In an embodiment, a determination may be made as to how much amount of money and/or resources would a construction company save upon building the physical product assembly. Further, in an embodiment, the Feasibility Evaluator module 206 may be provided with data relating to economies of scale related to the feasibility of building the physical product assembly. In such a scenario, the Feasibility Evaluator module 206 may also factor in economies of scale while evaluating the feasibility of building the physical product assembly. In an embodiment, a determination may be made as to how many physical product assemblies are needed to break even and obtain profit. Further, the Feasibility Evaluator module 206 may present a feasibility score and a confidence score, optionally. The feasibility and confidence scores are computed using a multifactorial computation by factoring BIM, design intent, and prevailing needs. The score will be a numerical range up to 100 in terms of viability of the solution. The confidence score is a measure of systems recommendation based on ML and current situational factors. For example, the feasibility score may factor in number of stories of the building, ecology of the ground, type of material used to construct, cost and timeline factors, and additional inputs mandated through design intent of the user. The scores may be related at least to the physical product assembly. In an embodiment, the Feasibility Evaluator module 206 may determine whether the one or more custom construction artefacts may be prefabricated with a confidence score above a feasibility threshold. For example, the feasibility threshold can be set by a system administrator (or user) to be above 95% and a confidence score of about 90%.

In summary, the Feasibility Evaluator module 206 may determine the practicality of achieving construction project objectives, for example, of completing the construction project on time, within budget, etc. The Feasibility Evaluator module 206 may evaluate the feasibility of accomplishing a process output by the Design Intent Analyzer module 204, for example, dissembling, shipping, and reassembling a prefabricated artefact manufactured offsite and brought to a project site in a timely and cost-effective manner. The Feasibility Evaluator module 206 may also determine if there are economies of scale of manufacturing an artefact offsite (e.g., can the design or manufacturing set up be reused for a different project and so forth) to break even or profitability, etc. The Feasibility Evaluator module 206 may then output a feasibility score, which may also include a confidence score, of executing a specific process output by the Design Intent Analyzer module 204 having regard to availability of raw materials, supply chain information, labor utilization information, and other such factors.

In an embodiment, the Prefab Design Composites module 208 may compute optimal designs to meet the set objectives for the physical product assembly. The Prefab Design Composites module 208 may compute optimal designs for the manufacture of the one or more custom construction artefacts by factoring in physical elements, nature of the construction, geography, local topology, etc., and may output a set of optimal design parameters to meet the assembly requirements, etc. The optimal design parameters may also factor in data from BIM introspection, existing design library data, and material and environmental constraints. The Prefab Design Composites module 208 may include a user interface (e.g., a graphical user interface) to facilitate user inputs for design of the one or more custom construction artefacts. In an embodiment, the user inputs may be related to one or more properties (as discussed above) and/or one or more characteristics (as discussed above) of the one or more custom construction artefacts. Thus, an optimal design output from the Prefab Design Composites module 208 may enable the computing system 200 to calibrate, customize, and configure design elements of the one or more custom construction artefacts to meet the overall construction objectives. In an embodiment, the Prefab Design Composites module 208 may operate as at least a part of a design generator unit enabling computation of optimal designs. It is noted that the design generator unit may also include other modules described herein.

In an embodiment, the CDP module 210 may create and enable design and manufacture of CDPs. The physical products are not mere one-off composition but are generated with a view to creating a reusable set of libraries which may be used for other construction projects based on a type of construction, a prevailing need, etc. The CDPs are usually correlated to the needs analyzed from the BIM data and are digital artefacts based on which physical products are built out. The digital artefacts lend themselves for customization (e.g., color, dimensions, design intent, etc.). In an embodiment, the CDP module 210 uses visual constraints to enable product simulation and allows a user to visualize a physical product taking shape and provide the ability to introspect and visually modify the physical product that is being configured. The CDP module 210 may interface with three dimensional BIM models and may allow users to interact and query attributes, spatial definitions, elements, their properties as defined in a BIM model in a real-time visually enhanced user interface so as to allow further customizations and modifications of the CDPs. In an embodiment, a user may query a BIM model by playing around with properties and characteristics of the BIM model, and seeing the output based on the changes made to the BIM model. For example, the user may change the color, shape, material, and dimension of the CDPs, and visually see the impact of the changes on the three-dimensional BIM models. The CDP module 210 may also provide feedback on whether a proposed modification of a physical product is feasible from design, utility, and overall construction objective perspectives as well. The CDP module 210 may output a digital twin of a construction artefact along with distinct options and information on cost, time to manufacture, ease of manufacture, etc.

The creation and enablement of the design and manufacture of CDPs unlocks a new potential of Industrialized Construction (IC) through development of a strategy and approach to achieve a two-way data flow among designers, suppliers, manufacturers, and assemblers. The CDPs enable automation and also result in streamlining project delivery of a customized physical product from design of the physical product through manufacture and/or assembly of the physical product.

In an embodiment, a File to Factory (F2F) service may be hosted by the computing system 200. Briefly here, the F2F service streamlines design through manufacturer and/or assembly of physical products. Details of the F2F service is further discussed herein.

### 3.2 Factory Interface & Delivery Logistics Subsystem

The Factory Interface and Delivery Logistics subsystem (Subsystem 2) may include, but is not limited to, a Factory Interface module 214, an Optimizer module 216, a Monitor Production Efficiencies module 218, an Interface to Master Schedule module 220, and a Delivery Logistics module 222. Each of these modules may implement one or more deep learning, AI, and/or ML techniques described herein.

In an embodiment, the Factory Interface module 214 may receive a request related to a project for which a project manifest needs to be created. The request may be related to a construction project, a manufacturing project, or a combination of both. For example, the request may be related to executing an end-to-end construction project or building components (such as walls, trusses, fixtures, windows, plumbing, floor components, roof components, etc.) for a construction project. Additionally, or alternatively, the request may relate to the manufacture of the one or more custom construction artefacts (as discussed above). For example, in an embodiment, the computing system 200 may determine that the one or more custom construction artefacts may be manufactured/prefabricated with a confidence score above a feasibility threshold, and provide a request associated with the one or more custom construction artefacts to the Factory Interface module 214. Optionally, the computing system 200 may seek an approval (input) from a user, for example, via a user interface, prior to providing the request related to the one or more custom construction artefacts to the Factory Interface module 214. In an embodiment, the Factory Interface module 214 may receive the request related to the project directly from a user or a client associated with the construction and/or the manufacturing project. For example, the user may be the end user of the artefact being manufactured. In another embodiment, the Factory Interface module 214 may receive the request related to the project from one or more manufacturers, suppliers, vendors, and the like, who intend to work on the construction and/or the manufacturing project on behalf of the end user or the client.

In an embodiment, the Factory Interface module 214 may determine project objectives related to the request. The term project objectives, as used herein, may refer to an intent, a goal, or an objective that should be met, to an extent, while executing the construction and/or the manufacturing project. These may include, but are not limited to, a time objective (e.g., a timeline for a project or a part of the project), a cost objective (e.g., a budget for a project or a part of the project), a quality objective (e.g., a quality standard for a project or a part of the project), a sustainability objective (e.g., minimizing CO2 emissions and other emissions that may result in global warming for a project or a part of the project), an efficiency objective (e.g., a supplier and/or factory efficiency target for a project or a part of the project), and a health objective (e.g., the use of non-toxic materials for a project or a part of the project) associated with the project. For example, the project objective for the construction of a building may include a timeline goal (in an example, say, of six months). In one scenario, the Factory Interface module 214 may set the timeline of six months as the project objective for the building construction project. In another example, the project objective for a construction project for a building may be a sustainability-based objective. For example, the goal may be to construct a building using sustainable construction and/or manufacturing techniques, and/or designing aspects of the building so that it operates as a green or a sustainable building after the completion of the construction. For example, one of the project objectives may be for the building to meet set standards for sustainability, such the LEED (Leadership in Energy and Environmental Design) standard, which is one of the most widely used green building rating system. In this case, the Factory Interface module 214 may select raw materials, suppliers, construction equipment, processes, and the like, with the objective of meeting sustainability standards. For example, the Factory Interface module 214 may choose non-toxic, sustainability produced or recycled materials which require little energy to produce, use manufacturing processes that run on clean energy, track and minimize carbon emissions, design buildings that have energy efficient windows, a green roof, conservation and/or recycling of water, solar energy based power systems, etc.

In an embodiment, the Factory Interface module 214 may receive the project objectives from the Design Intent Analyzer module 204 for the manufacture of a custom construction artefact, as discussed above. In another embodiment, the project objectives may be a combination of multiple objectives, such as, a budget goal in association with a timeline for completing the project. In this case, both the budget and the timeline goals may be considered by the Factory Interface module 214 as the project objectives.

Further, in an embodiment, the Factory Interface module 214 may determine a set of constraints relevant to the manufacturing and/or the construction project. The set of constraints may refer to one or more parameters, data, etc., associated with the manufacturing and/or the construction project, such that, the set of constraints define what can be achieved with the material, manufacturing, and logistical systems. In an embodiment, the set of constraints may include, among others, manufacturing constraints, logistical constraints, supply constraints, engineering constraints, and material constraints. In an embodiment, the set of constraints may be derived, at least in part, through a knowledge repository. The knowledge repository may be the same as or, alternatively, different from the data repository 130 of FIG. 1. The knowledge repository may refer to a database and/or a library of information accessible to the computing system 200. In an embodiment, the knowledge repository may include parameters related to the manufacturing and/or the construction project and a data feed from multiple data sources associated with the manufacturing and/or the construction project. For example, the computing system 200 may record parameters associated with each executed project in a library for future use. Thus, in this case, the knowledge repository may include parameters such as historical data associated with the project or a similar project. Further, as an example, for a request to manufacture customized window panes for a building, the Factory Interface module 214 may access the knowledge repository to determine if there already exists a prior manufacturing project with similar specifications. If yes, the parameters associated with the prior manufacturing project are determined as the set of constraints, in part, for the current project. In an example, these parameters may refer to the time and/or cost to manufacture a given unit of the specific window panes in the past, the list of suppliers used, assembly instructions, logistical challenges, etc., which are accessible to the Factory Interface module 214 via the knowledge repository. The parameters may also refer to an industry data associated with the project, such as, industry averages in executing a similar project. For example, the knowledge repository may provide information about the average time, cost, labour, etc., it takes for a factory and/or a manufacturer of a similar nature, to execute a similar project, at a given time. Further, the parameters may also refer to the execution details for the project, such as, assembly instructions, and a forecast data associated with the project, such as, an alert forecasting a delay at a supplier’s end based on historical data associated with the supplier.

As described above, the knowledge repository may also include a data feed from multiple data sources associated with the manufacturing and/or the construction project. In an embodiment, the data feed from the data sources may include data from, among others, manufacturers, suppliers, designers, and assemblers. The data feed from these data sources may relate to sourcing information, supply-chain considerations, logistical information, geolocation data, environmental data, etc. The data feed from the multiple data sources may be dynamic in nature, that is, the data feed may be updated in real-time to reflect any changes in information received from the multiple data sources. For example, due to certain events, there may be a disruption in the supply-chain associated with a manufacturing project. As a result, the data feed associated with the supply-chain in the knowledge repository may be updated to reflect the disruption information.

In an embodiment, the Factory Interface module 214 correlates the set of constraints with the project objectives, and evaluates the correlated set of constraints and the project objectives to generate an optimized model. In an embodiment, the Factory Interface module 214 employs a number of deep-learning, Artificial Intelligence (AI), and Machine Learning (ML) algorithms to correlate and evaluate the set of constraints and the project objectives, and to generate the optimized model. For example, some of the project objectives may include optimizing the cost to manufacture, supply-chain related logistics, optimizing the cost of labour or manpower, optimizing the cost of equipment or machinery, optimizing the cost of material consumption, maximizing outputs, etc., within a given set of constraints. Further, as previously discussed, the set of constraints may include dynamic variables, such as real-time data feed from data sources, including unforeseen situations that are encountered surprisingly, dynamic streaming of parameters related to the project, and manual updates to input data and scenarios made by a user. The Factory Interface module 214 correlates the set of constraints with the project objectives, and continually evaluates the correlated set of constraints and the project objectives at a given moment to arrive at the optimal model. In an embodiment, a schedule and/or workflow associated with a manufacturing or a construction project may be broken down or decomposed into its elemental attributes, and these elemental attributes may be kept in a graph form for correlation and evaluation by the Factory Interface module 214. In an embodiment, the Factory Interface module 214 may employ AI/ML algorithms and/or deep learning techniques for evaluating the graph, as discussed above, and to try to compute a shortest path between nodes of the graph, for example. In this case, the computation of the shortest path between nodes of the graph, given the set of constraints, may be evaluated by the Factory Interface module 214 to generate the optimized model. Some of the deep learning techniques and AI/ML algorithms to generate the optimized model may include, among others (but not limited to), node2vec techniques for prediction, Greedy Algorithm, Dijkstra’s algorithm, and Profit Maximization algorithms. For example, in an embodiment, the Factory Interface module 214 may use Profit Maximization algorithm in evaluating a supply and demand graph associated with the project. In this case, one of the project objectives may be to maximize efficiency and/or profits associated with the project, hence, the Factory Interface module 214 may apply Profit Maximization algorithm to evaluate an intersection point of a revenue axis and a cost axis on the graph, which indicates the optimized model for a factory, for example, to maximize profits. In an embodiment, the Factory Interface module 214 may use a Greedy Algorithm to evaluate if combinations and sequences of construction and/or manufacturing tasks and activities can lead to better efficiencies. This is a heuristic-based approach. In an embodiment, the Factory Interface module 214 may use Dijkstra’s Algorithm to find correlations and to generate an optimized model to getting a set objective accomplished from a wide source of related tasks. It should be noted that the Factory Interface module 214 can additionally leverage: a probabilistic, heuristic, deterministic or other suitable methodologies for computational guidance, recommendations, machine learning or combination thereof, to generate the optimized model. Further, any suitable model (e.g., machine learning, non-machine learning, etc.) and algorithm can be used in the system of the present disclosure.

In an embodiment, the Factory Interface module 214 creates a project manifest based on the optimized model for executing the manufacturing and/or the construction project. The term the project manifest, as used herein, may refer to a workflow, document, circular, guide, etc., associated with the manufacturing and/or the construction project that provides an optimized model covering time, cost, and schedule aspects from project, manpower, equipment, source, material, logistics, and processes front. In an embodiment, the project manifest may be created for manufacturing a custom construction artefact, as discussed above. Thus, the project manifest may include a sequence in which certain components or products need to be manufactured in coordination with construction schedule and project status. The manufacturing schedule (associated with the timeline of manufacturing the one or more custom construction artefacts) may feed into over a construction master schedule manager (associated with the timeline of completion of the whole construction project) to ensure that the custom construction artefacts are manufactured in the right sequence at the right time to keep the construction project on track. In an embodiment, the Factory Interface module 214 may optionally refer to the project manifest to coordinate sourcing of materials in accordance with a manufacturing schedule. The Factory Interface module 214 may determine and dynamically source the material from a specific supplier depending on availability, cost, and other project considerations. In an embodiment, the project manifest may provide step-by-step instructions associated with a manufacturing project, right from sourcing the raw materials, transportation of materials, optimal way of manufacturing, optimal sequence of manufacturing, assembly instructions, shipping and logistical information, etc. Thus, the Factory Interface module 214 may manage the overall process workflow of a manufacturing and/or construction project, thus relieving the manufacturers or factories of scheduling, stocking, and procurement issues and delivery logistics planning.

FIG. 2B illustrates an exemplary overview of the project manifest, according to an embodiment. As shown in FIG. 2B, a processor 244, such as in association with or as a part of the Factory Interface Module 214, receives the set of constraints 238 and the project objectives 240 as inputs. The set of constraints 238 may be received from a knowledge repository 236, as described above. The processor 244 may apply correlation techniques, as described above, on the set of constraints 238 and the project objectives 240 to generate an optimized model 246. The optimized model 246 may include outputs from one or more AI and/or ML algorithms, as discussed above. In an embodiment, the optimized model 246 may be presented to a user for verification and/or to receive any user modifications to the optimized model 246. Further, as shown in FIG. 2B, the optimized model 246 is used to create a project manifest 248, that includes details related to the execution of a project. For example, the optimized model 246 may be rearranged and/or modified to create a user-friendly project manifest 248, that may provide details associated with the project in an organized manner. For example, for a manufacturing project, the project manifest 248 may indicate sourcing details, such as, raw materials to be sourced along with the suggested suppliers and/or the cost associated with the raw material. Additionally, the project manifest 248 may indicate the sequence of manufacture in detail along with a time and/or completion schedule associated with each manufacturing step. Further, the project manifest 248 may include information associated with assembly, shipping, and logistics, as illustrated in FIG. 2B. In an embodiment, the project manifest 248 may be displayed on a user interface associated with a user. The user in the above discussed example may be a manufacturer, for example. The user may make modifications to the project manifest 248. For example, the user might prefer a Supplier 3 over the suggested Supplier 2, as shown in FIG. 2B. The user may accordingly edit the project manifest 248 to change Supplier 2 to Supplier 3. The project manifest 248 is automatically updated accordingly to reflect any impact this change may have on the rest of the process and/or schedule. For example, due to the location of Supplier 3, it may be forecasted that the project schedule may be impacted by a week. Thus, the project manifest 248 may be updated to modify time schedule associated with one or more steps of the manufacturing process. It should be noted that the project manifest 248 illustrated in FIG. 2B is for exemplary purposes only, and the project manifest 248 may be presented to a user in any form. For example, in an embodiment, the project manifest 248 may be presented to a user in the form of a dashboard, an audio, a video, an article of virtual reality, in a story using augmented reality, and the like.

In an embodiment, the Optimizer module 216 may be an interactive module that determines how to optimally execute the manufacturing and/or the construction project in view of real-time data and/or user modifications. In an embodiment, the Optimizer module 216 may analyze real-time data associated with a set of constraints for a project. For example, the Optimizer module 216 may receive real-time data regarding a delay in the supply of a raw material from a supplier. The Optimizer module 216 may analyze the received data, and may determine an impact of the analyzed data on the project objectives associated with the project. For example, one of the project objectives may be to complete the construction project within a given time. Thus, the Optimizer module 216 may analyze the impact of the raw materials delay on the overall timeline goal associated with the project. Accordingly, the Optimizer module 216 may generate an updated project manifest, if needed, based on the determined impact. For example, the Optimizer module 216 may generate an updated project manifest that may provide a list of alternate suppliers for sourcing the raw materials to complete the construction project on time. In an embodiment, a user may provide modifications to the project objectives or provide a custom project objective. For example, the user, such as a manufacturer, might want to modify the manufacturing process provided in the project manifest, after running into an unexpected equipment failure. The Optimizer module 216 may analyze the modifications, and generate an updated project manifest providing an optimized model of executing the manufacturing project in view of the modifications.

In an embodiment, the Monitor Production Efficiencies module 218 may monitor production efficiencies related to a manufacturing and/or a construction project. For example, for a project related to the manufacture of custom construction artefacts, the monitored efficiencies may or may not be related to efficiencies of the one or more factories in which the custom construction artefacts are manufactured or are in the process of getting manufactured. Further, in an example, the monitored efficiencies may be related to efficiencies of one or more raw material suppliers which provide raw materials for manufacturing the custom construction artefacts. In general, the monitored efficiencies may be related to efficiencies of one or more modules of the computing system 200 and/or to one or more processes involved during the building of a construction project. In an embodiment, in order to monitor efficiencies related to the manufacture of the custom construction artefacts, the Monitor Production Efficiencies module 218 may be provided a real time feed from one or more raw material suppliers and/or one or more factories. In an embodiment, the Monitor Production Efficiencies module 218 may further provide a causality data and/or a remedial data associated with the monitored production efficiency. For example, for a manufacturing project, the Monitor Production Efficiencies module 218 may determine, based on real-time data from a factory, that the production efficiency for the factory is n number of units manufactured in a day. However, the project objective associated with the project indicated an efficiency objective of m-unit production in a day, where m>n. The computing system 200 (in an example, the Monitor Production Efficiencies module 218) may apply AI and/or ML algorithms to determine the cause or the reason for the lower production efficiency. For example, the Monitor Production Efficiencies module 218 may determine that a poor-quality raw material supplied by a particular supplier is resulting in quality related issues and reworks, thus, lowering the overall production efficiency of the factory. This data may be provided to the factory supervisor as a causality data for the lower production efficiency. Further, the Monitor Production Efficiencies module 218 may determine a remedial data associated with the production efficiency. For example, in an embodiment, the Monitor Production Efficiencies module 218 may apply Artificial Intelligence (AI) and/or Machine Learning (ML) algorithms to determine ways to improve the production efficiency given the set of constraints associated with the project. Thus, in the example discussed above, the Monitor Production Efficiencies module 218 may provide recommendations with respect to alternate suppliers for the raw material to address the quality issue of the raw material. The Monitor Production Efficiencies module 218 may provide a combination of strategies and suggestions to improve the production efficiency to meet the efficiency objective of m-unit production in a day, for example.

In an embodiment, the Interface to Master Schedule module 220 may perform adjustments to the timelines associated with the various stages of a manufacturing and/or a construction project. Said adjustments may be necessitated at least because of one or more avoidable and/or unavoidable delays associated with various stages involved in the design and execution of the project. For example, there may be delays at one or more factories in which custom construction artefacts are manufactured or are in the process of getting manufactured. The Interface to Master Schedule module 220 may continually monitor these updates and perform adjustments to subsequent project workflow timelines, accordingly.

In an embodiment, the Delivery Logistics module 222 may provide suggestions, outcomes, and deadlines regarding delivery of work products at each and every stage (phase) of a construction and/or a manufacturing project. In an embodiment, the Delivery Logistics module 222 may output timelines regarding the completion of each and every stage (phase) of the construction process well in advance before the completion of the respective stages (phases) of the construction process.

### 3.3 Marketplace Subsystem

Furthermore, in an embodiment, the Marketplace subsystem (Subsystem 3) or digital marketplace may include, but is not limited to, a Marketplace Debut module 224, a Digital Customization Interface module 226, a Bid Manager module 228, a Factory Interface module 230, an Efficiency Analyzer module 232, and a Support and Maintenance module 234. Each of these modules, alone or in a combination thereof, may create a digital marketplace that provides a platform to support monetization of custom construction artefacts and/or project manifests, as described above. Each of these modules may implement one or more AI/ML techniques described herein.

In an embodiment, the Marketplace Debut module 224 may receive a bidding request for a request related to a project from bidders who intend to work on the project. In an embodiment, the project may include, but is not limited to, a manufacturing project, a construction project, a customization request on a pre-existing project or artefact, and a custom construction artefact. In an embodiment, the Marketplace Debut module 224 may provide details associated with the request related to the project to bidders, such as, vendors, manufacturers, designers, suppliers, etc., who might be interested in working on the project.

Further, in an embodiment, the Digital Customization Interface module 226 may provide an interface for users to customize pre-existing project and/or artefacts available for sale, for example, on the digital marketplace. For example, a user may access the digital marketplace interface to provide details associated with a request for customization of an artefact available for sale, such as, window panes. The user may request a custom frame for the window panes that are available for sale. The Marketplace Debut module 224 and/or the Digital Customization Interface module 226 may receive this customization request as a request for a project from the user. The Marketplace Debut module 224 may provide details associated with this request on the digital marketplace for bidders to review, and/or may send the request directly to the bidders who might be interested in working on the project. The bidders may review the customization request, and if interested, may provide a bidding request to the Marketplace Debut module 224. The bidding request may indicate an interest from potential bidders, such as, vendors, manufacturers, designers, suppliers, etc., who might be interested in working on the project. For example, a custom window frames manufacturer might intend to work on the customization request, and submit his interest as a bidding request to the Marketplace Debut module 224. The Marketplace Debut module 224, on receiving the bidding request from the bidder, may provide a set of recommendations to the bidders based on the optimized model generated for the project, as discussed above. For example, the Marketplace Debut module 224 may determine a pre-existing project manifest created for the window panes available for sale on the digital marketplace. The Marketplace Debut module 224 may analyze the pre-existing project manifest, in view of the customization request and one or more factors associated with the bidder, such as, a location of the bidder, to generate an optimized model, using the techniques described above. The Marketplace Debut module 224 may provide a set of recommendations, such as, but not limited to, a manufacturing cost forecast, a project manifest associated with the project, a manufacturing time forecast, and materials supplier information, to the bidders based on the optimized model generated for the project.

In an embodiment, the Bid Manager module 228 may receive bids related to the project from the bidders based on the set of recommendations provided by the Marketplace Debut module 224. For example, based on the manufacturing cost forecast provided by the system, the bidder, a manufacturer for window panes, for example, may submit a bid on the custom window panes manufacturing project. Similarly, other bidders who intend to work on the project may submit bids on the digital marketplace for the project. The Bid Manager module 228 receives bids from all bidders who intend to work on the project. In an embodiment, the Bid Manager module 228 arranges the received bids based on the one or more project objectives. For example, a project objective associated with the project may be to complete the project in two weeks. The bidders may provide details of their manufacturing timeline, and the Bid Manager module 228 may arrange the bids in a manner that the bidders that aim to deliver the project with the timeframe of two weeks are arranged in a manner that they are presented to the user first, followed by the rest of the bids. It should be noted that there may be other ways of managing and/or arranging the received bids, and the current disclosure is not limited to the example discussed herein. In an embodiment, the Bid Manager module 228 may provide the arranged bids related to the project on a digital marketplace interface for a user to review the submitted bids and select the one or more bidders to work on the project.

In an embodiment, the Factory Interface module 230 may provide an interface to one or more factories for manufacturing one or more construction artefacts associated with the project based at least on bids received by the Bid Manager module 228. In an embodiment, the Factory Interface module 230 may create a project manifest for the project for which the bid is received, based on the techniques discussed above.

In an embodiment, the Efficiency Analyzer module 232 may monitor production efficiencies related to the project associated with the received bid. Further, the Efficiency Analyzer module 232 may provide a causality data and/or a remedial data associated with the monitored production efficiency, based on the techniques discussed above.

In an embodiment, the Support and Maintenance module 234 may output one or more suggestions on how to provide support and maintenance of the project and/or the one or more custom construction artefacts manufactured utilizing the computing system 200. This is one of the many technical advantages that the computing system 200 has to offer.

FIG. 2C illustrates an exemplary overview of a digital marketplace 250, according to an embodiment of the present disclosure. The digital marketplace 250 may refer to the Marketplace subsystem (Subsystem 3) which may include, but is not limited to, a Marketplace Debut module 224, a Digital Customization Interface module 226, a Bid Manager module 228, a Factory Interface module 230, an Efficiency Analyzer module 232, and a Support and Maintenance module 234. In an embodiment, the project manifest 248 created by the Factory Interface Module 214 and/or the processor 244 based on the optimized model 246 may be accessible to the digital marketplace 250. Further, a user may access a CDP library 254 to identify a CDP that the user wants manufactured. Additionally, the user may want to customize the existing CDP and may invite a bid 252 indicating the custom CDP that needs to be manufactured. In an embodiment, the user may invite a bid at least, in part, based on the information received from the project manifest 248. Additionally, the request for bid details may be provided to the Factory Interface Module 214 for making any modification, if required, to an existing project manifest 248 for the CDP. The invitation and/or request for bid may be sent to one or more suitable bidders, such as, Bidder A 256 and Bidder B 258, as shown in FIG. 2C. In an embodiment, Bidder A 256 may access the value-added services provided by the digital marketplace, as discussed above. For example, Bidder A 256 may request for a detailed project manifest 248 associated with the manufacture of the custom CDP and/or may request a set of recommendations associated with the manufacture of the custom CDP to make an informed bid. In an embodiment, Bidder A 256 may receive a set of recommendations associated with a forecasted cost, forecasted timeline, and suggested suppliers for raw material associated with the manufacture of the custom CDP. Bidder A 256 may consider the provided set of recommendations to decide a bidding amount, for example, for the manufacturing project. As shown in FIG. 2C, Bidder A 256 and Bidder B 258 may submit bids 260 for the manufacturing project. The submitted bids details may be provided to the Factory Interface Module 214. The Factory Interface Module 214 and/or the processor 244 may update the optimized model 246 and/or the project manifest 248 based on the information received from the digital marketplace 250.

In another example, the digital marketplace 250 may be used by one or more suppliers to request a bid for a construction and/or a manufacturing project. In this case, a supplier may invite a bid with details of the construction and/or a manufacturing project, as a whole, or a part of the construction and/or a manufacturing project. The bid request may be sent to one or more bidders, such as Bidder A 256 and Bidder B 258, as illustrated in FIG. 2C. The one or more bidders may access the project manifest and/or a set of recommendations associated with the construction and/or a manufacturing project to submit a bid. Additionally, or alternatively, the bidder and/or the supplier may request a project manifest to be created for the construction and/or a manufacturing project in order to optimize the execution of the project.

It should be noted that the illustration provided in FIG. 2C is for exemplary purposes only. Digital marketplace 250 may utilize project manifest 248 for a project in various ways. For example, the project manifest 248 may be created after submission of bids by one or more bidders. In one case, a bidder may request, by paying an additional fee, a personalized project manifest 248 for a custom CDP project. The bidder may request for the project manifest 248 before or after the selection of the final bid by the user. The project manifest 248 may be utilized by the bidder for optimizing the execution of the custom CDP project.

### 4.0 File to Factory Service

In various embodiments, a File to Factory (F2F) service may be hosted by the server computer 106 of FIG. 1, for streamlining design through manufacturer and/or assembly of physical products. The F2F service utilizes a software application that enables collaborative teams to bring their knowledge and capabilities into customizable products that restrict BIM users/designers to design within the realm of what is achievable by specific supply chain members. The customizable products may have embedded rules to automate the generation of information required to actually manufacture and/or assemble the physical product. The software application connects all parties with two-way data flow as meta-data remains in the cloud.

The software application incorporates CDPs for integrating design through manufacturing and/or assembly of each physical product. CDPs incorporate constraints and efficiencies in areas such as manufacturing, and limit BIM users/designers to specifications within parameters and options that are consistent with the constraints. CDPs are developed for a specific physical product by teams which may include members, such as, one or more CDP product designers, assemblers, manufactures, material suppliers, or consultants. Once BIM users/designers have specified a custom physical product within the allowable constraints, the CDP outputs instructions to a project delivery team to make the customized physical product. The CDP is represented through an easily adaptable and simplified graphical model (e.g., both 2D and 3D, in some embodiments) that may operate as a parametric component within existing third-party design/BIM software, and link in parallel with a cloud platform which hosts the associated data and related algorithms to convert the data into the formats required to streamline project delivery.

The software application further incorporates a configurator plugin for BIM software where components are represented through their own interface with a component configurator which has the adaptable parameters represented. The software application also further incorporates a developer plugin that sits within visual coding platforms to enable CDP developers and owners to create, adapt, and monetize CDPs.

The F2F service incorporates at least one web-based portal for the CDP owners, CDP developers, CDP users (BIM users/designers), and CDP customers to use, manage, review, and/or purchase CDPs.

Inclusive in this disclosure is a new and unique file type, known as a .cdp file (pronounced “dot CDP”). This unique file type represents each customizable digital product in its own readable file format to be exported, shared, and imported between users of this disclosure on its platform including the digital construction elements’ design marketplace. CDP files may be bought and sold on the digital construction elements’ design marketplace as .cdp files, and interpreted in BIM software through the user/designer plugin as .cdp files.

FIG. 3 is a schematic diagram illustrating an overview of use of the F2F service. The F2F service is based around the notion of component-based and parametric design, relying on and enabling the Architecture, Engineering, and Construction (AEC) industry to build upon already established BIM software platforms that designers already use, to build parametric components and streamline project documentation. The F2F service teamed with the CDPs transforms this notion into a sophisticated approach where the components are much more than just graphical representation.

CDPs are a sophisticated algorithm in the AEC industry which is developed specific to the design, manufacturing, and scheduling of a to-be-built physical product. Building upon the logic of BIM and parametric design, the CDP restricts design changes to the input parameters. These input parameters are related directly to the capabilities of the embedded and associated supply chain. These input parameters bring the knowledge, that commonly sits in silo with a long list of different suppliers and consultants, into a simple digital component with a set of adjustable parameters directly related to what is achievable.

For example, the associated supply chain and CDP owners create a CDP by identifying input data (e.g., specifications and constraints, including manufacturing capabilities) and output data (e.g., instructions, schedules, approval drawings, manufacturing machine files), and embedding the data into an algorithm that remains native to the cloud. The CDP is created for the integrated design and production of a given to-be-built physical product. The associated supply chain team may include, but is not limited to, cost estimators, material suppliers, manufacturers, assemblers, and distributors. The CDP owner may or may not be a member of the associated supply chain team.

In the example of FIG. 3, the CDP and all associated meta-data resides in the cloud. As shown in FIG. 3, the building designers may access the CDP and make design choices and/or changes within the constraints of the adjustable data. The adjusted data resides in the cloud. Once a building designer has specified the design of a physical product within the constraints, the CDP may automatically create the output data for production of the physical product by one or more of the associated supply chain team members.

The CDP is represented through an easily adaptable and simplified graphical model (e.g., both 2D and 3D in some embodiments) that may operate as a parametric component within existing third-party design/BIM software and link in parallel with a cloud platform which hosts associated data. The associated data makes up an exact replica of the built form down to the finest details but does not represent this graphically. The associated data is left as raw data within the cloud.

With each change made by the building designers, the CDP automatically adjusts the output data based upon the inbuilt relationships determined (parametrically). These adjustments enable the correct details and output to streamline the delivery of the physical product to be available in real time. The raw meta-data that exists within the algorithm may be adjusted to the required format to make a seamless link for project delivery dependent upon the manufacturer, builder, and/or software.

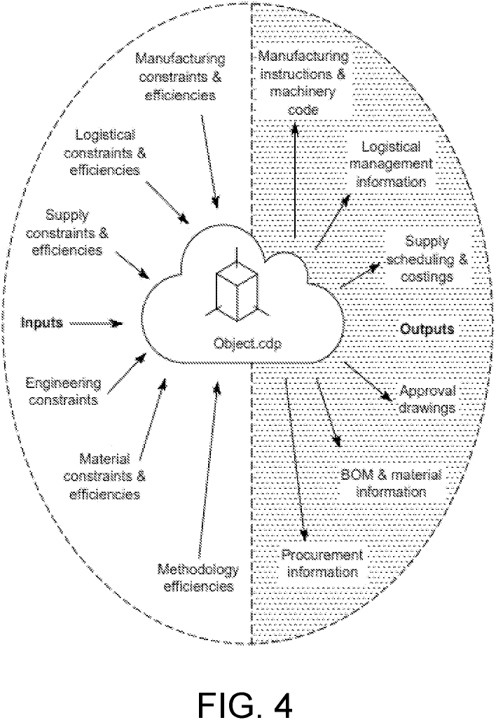

FIG. 4 is a schematic diagram illustrating the various inputs and outputs to a CDP. The non-limiting set of inputs to the CDP shown in FIG. 4 includes manufacturing constraints and efficiencies, logistical constraints and efficiencies, supply constraints and efficiencies, engineering constraints, material constraints and efficiencies, and methodology efficiencies. Further, the non-limiting set of outputs of the CDP shown in FIG. 4 includes manufacturing instructions and machinery code, logistical management information, supply scheduling and costing, approval drawings, bill of materials, and material information, and procurement information. As with the input parameters, the amount of output data that may be extracted is extensive. By adding the required output code to transform the data, the exact output to create the physical product may be created autonomously from the adjusted data created by the BIM user.

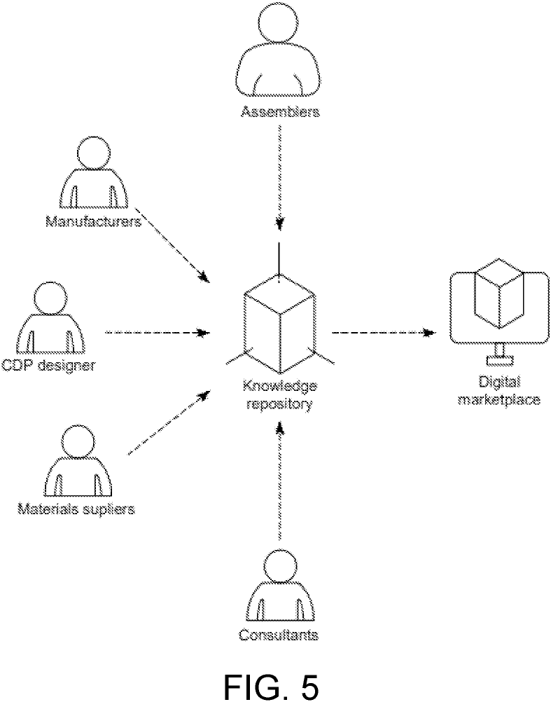

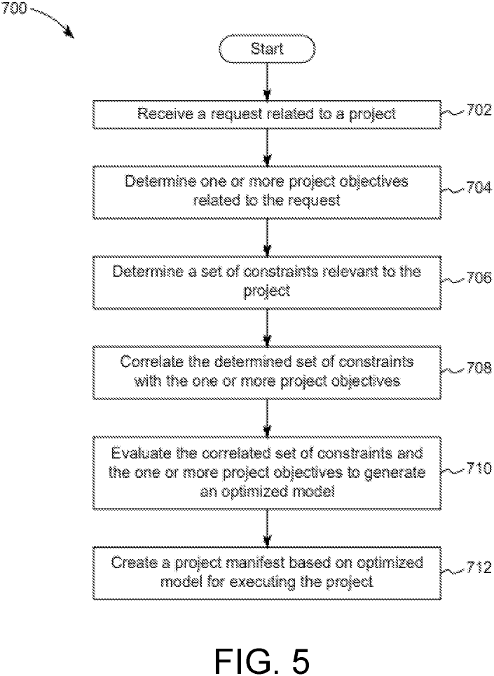

FIG. 5 is a schematic diagram illustrating example inputs to the knowledge repository for the development of a CDP. As illustrated in FIG. 5, the knowledge repository may be accessed by the digital marketplace. The CDP is developed utilizing Design for Manufacture and Assembly (DFMA) techniques teamed with computational design with the intention of enabling the AEC industry to move away from a service driven model and into the development of CDPs. FIG. 5 shows an exemplary collaborative team of CDP product designers, manufacturers, assemblers, material suppliers, and consultants that may combine their knowledge to make a CDP. The team is able to combine their knowledge into parametric models that restrict the adaptability of a to-be-built physical product based on what is actually achievable. The team is able to create a CDP that may provide the value of Early Contractor Involvement (ECT) without the need to physically engage in any work.

The associated team embeds the outputs particular to their requirements to streamline the delivery from digital product to build physical product. The associated team also links the relationships between elements to automate the design processes. For example, if a design change is made in one piece of a physical product, any implicit changes in other pieces of the physical product are automatically made. The outputs are customized specific to the associated team’s machinery, technology, software, and supply chain. The pricing, timing, scheduling, and methodologies are resolved to the finest of details for all elements.

In order to build a CDP, the manufacturing and construction methodologies are developed using DFMA techniques to break down each sub-element of the physical product and raw material into the finest detail, designing the process as well as the overall physical product. The DFMA approach ensures that the entire process of both manufacture and assembly is understood and designed into the CDP.

This process of understanding and designing every detail allows the CDP to be developed with the constraints of what can be achieved with the material, manufacturing, and assembly systems. These constraints may take the form of a set of parameters in the CDP. Computational design may be employed to build out the parametric algorithm which details the components as groups of objects that relate to one another. Adaptations in a related sub-component to changes in a first sub-component are dependent upon the set of parameters. These relationships are built as a set of rules within the algorithm that then produces the required input and geometry data to form a fully parametric model and graphical representation within BIM software.

Dependent upon the BIM software, the input and geometry data may vary but may still be produced using the same approach with extra code being added to the algorithm to convert the data into the form required. The algorithm itself may be hosted external to the BIM software through a cloud server with the output data connecting and rebuilding a parametric graphical representation within the BIM platform.

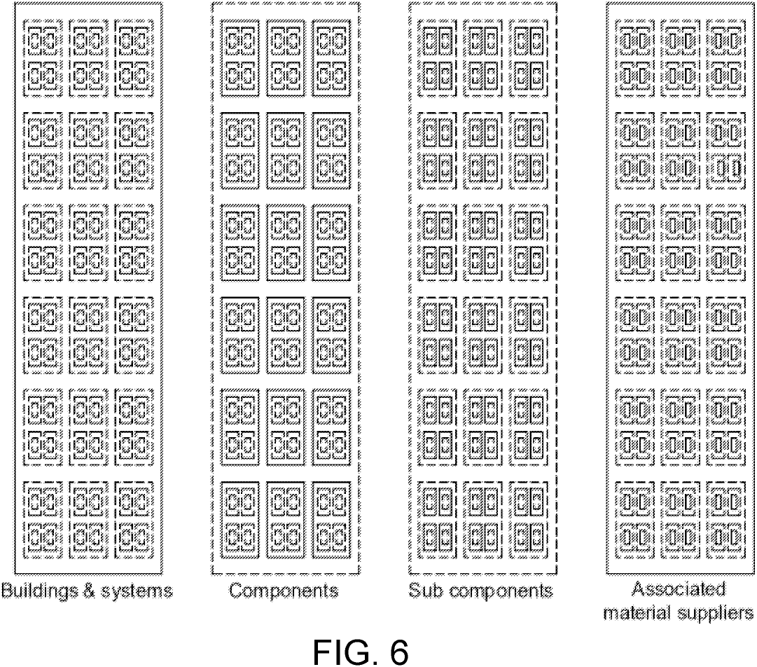

FIG. 6 is a schematic diagram illustrating an integration of multiple CDPs. FIG. 6 shows several different components that represent the design through manufacturing and/or assembly for making a building. Eighteen components are shown in the illustration of FIG. 6 with each component being made up of four sub-components. At its most granular level, a CDP encompasses the design through manufacturing and/or assembly of a physical product requiring at least one material to be obtained from a material supplier. As illustrated in FIG. 6, a material supplier is associated with each subcomponent. Assuming that each subcomponent is unique, the building illustrated in FIG. 6 could be built using seventy-two CDPs.

An example CDP is a bathroom pod CDP as a bathroom pod may be one of many physical products that make up a building. Although the CDP may be seen as the digital product, it is made of thirteen sub-components that are all CDPs in their own right. There are specific teams of suppliers, manufacturers, and assemblers associated with each of the thirteen CDPs. CDPs for each of the thirteen sub-components is granular down to the level of specifying the raw materials used to make the sub-component.

An example of one of the thirteen sub-components is a wall assembly for a bathroom pod. This wall assembly CDP may be made up of Light Gauge Steel (LGS) framing machines and assembly teams, sheathing, Computer Numerical Control (CNC) machining, screws, rivets, steel coil, and even logistics. The sheathing, screws, rivets, and steel coils are examples of associated materials as shown in FIG. 6. Each element of the CDP has its own restrictions, output requirements, and design knowledge. The wall assembly CDP may not only automatically create the G-code or CAM process for the CNC machine and LGS framing machine, it may also create a critical path for ordering and manufacturing of the elements.

Additionally, the wall assembly CDP may have inbuilt relationships between each element of all the CDPs for the bathroom pod. For example, if a basin is moved, it has a direct relationship to a faucet which also moves. This then has repercussions to sheathing, which requires the holes to be moved and the G-code for the CNC machine to be amended. Moving the basin also affects the framing, where the studs need to be placed, and in turn the G-code for the framing machine needs to be amended. All these changes may also affect the amount and location of fixings, plumbing, and required documentation and assembly instructions. The CDP automates this entire process and ensures the changes are both made correctly and that the required output data is generated to streamline the manufacturing, delivery, and assembly of the wall assembly.

### 5.0 Procedural Overview

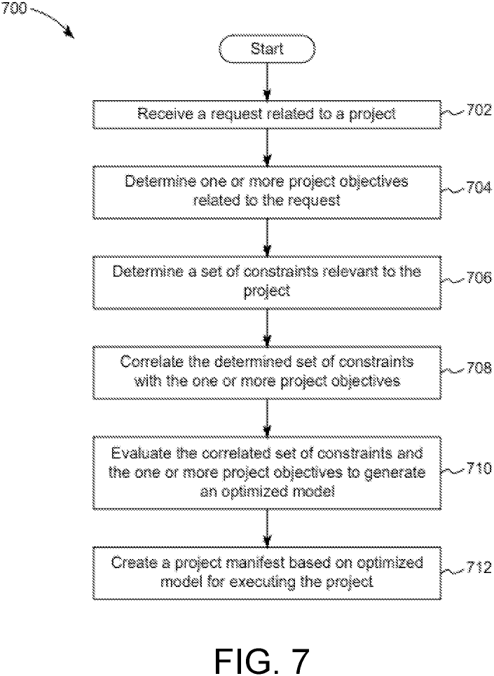

FIG. 7 is an exemplary flowchart 700 illustrating method steps of creating a project manifest for a manufacturing and/or a construction project, according to an embodiment. FIG. 7 may be used as a basis to code the method as one or more computer programs or other software elements that a computing device, such as the server computer 106 of FIG. 1, can execute or host.

In step 702, the computing device may receive a request related to a project. The project may be a construction project and/or a manufacturing project. The request related to the project may be received directly from a user computer (e.g., the client computer 104 of FIG. 1). The user computer may be associated with a user or a client associated with the construction and/or the manufacturing project. Additionally or alternatively, the user device may be associated with one or more manufacturers, suppliers, vendors, and the like, who intend to work on the construction and/or the manufacturing project on behalf of the end user or the client.

In step 704, the computing device may determine one or more project objectives related to the request received at step 702, as discussed above.

In step 706, the computing device may determine a set of constraints for the manufacturing and/or the construction project. The computing device may determine the set of constraints by deriving the set of constraints at least through a knowledge repository. The knowledge repository, as discussed above, may include one or more of parameters related to the project and a data feed from a plurality of data sources associated with the project. In an embodiment, the set of constraints may include, among others, manufacturing constraints, logistical constraints, supply constraints, engineering constraints, and material constraints, as discussed above.

In step 708, the computing device may correlate the determined set of constraints with the one or more project objectives associated with the manufacturing and/or the constriction project. As discussed above, the computing device may employ deep-learning, AI, and/or ML techniques to intelligently correlate the determined set of constraints with the one or more project objectives associated with the project.

In step 710, the computing device may evaluate the correlated set of constraints and the one or more project objectives to generate an optimized model associated with the manufacturing and/or the construction project. As discussed above, the computing device may use deep learning techniques and AI and/or ML algorithms to generate the optimized model. These may include, among others, node2vec techniques for prediction, Greedy Algorithm, Dijkstra’s algorithm, and Profit Maximization algorithms.

In step 712, the computing device may create a project manifest based on the optimized model for executing the manufacturing and/or the construction project. The project manifest may include a workflow, document, circular, guide, etc., associated with the manufacturing and/or the construction project that provides an optimized model covering time, cost, and schedule aspects from project, manpower, equipment, source, material, logistics, and processes front, as discussed above with reference to FIG. 2.

In view of the above description, the embodiments presented herein make the management of construction projects simple. This is achieved by improving the efficiencies in a construction cycle of a construction project by routing or executing certain aspects of a construction project off site to prefabricate several custom construction artefacts (e.g., building components such as walls, trusses, fixtures, windows, plumbing, floor components, roof components, etc.). Further, the embodiments presented herein provide a system, an apparatus, and a method for an efficient design, a project manifest, manufacture, and customization of construction artefacts or assemblies for a construction project.

In an embodiment, one or more apparatuses may be utilized in implementing embodiments consistent with the present disclosure. In an example, the one or more apparatuses comprise a memory and a processor coupled to the memory. In an example, the processor is configured to perform steps or stages consistent with the embodiments described herein.

In an embodiment, one or more systems may be utilized in implementing embodiments consistent with the present disclosure. In an example, the one or more systems may include one or more entities corresponding to an exemplary system 100 discussed in FIG. 1, the one or more entities being configured to perform steps or stages consistent with the embodiments described herein.

### 6.0 Example Intent-Based Factorization and Compuational Simulation Flow

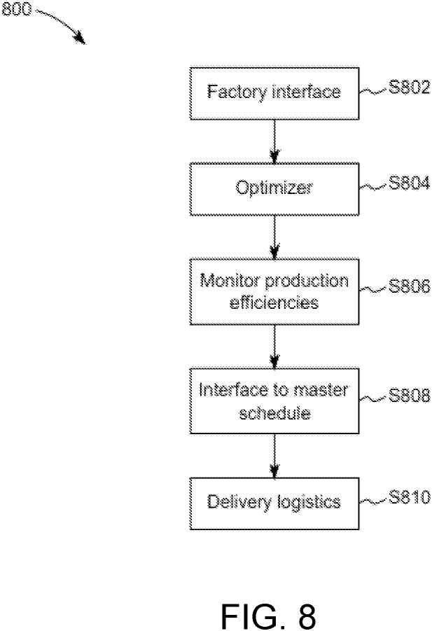

FIG. 8 is another exemplary flowchart 800 illustrating various subsystem modules and method steps of creating a project manifest for a construction and/or a manufacturing project, according to an embodiment. FIG. 8 discusses the various operations performed by the computing system 200 and/or an apparatus associated with the computing system 200 (simply referred herein to as computing system 200 for clarity) for creating the project manifest, according to an embodiment.

In step S802, the computing system 200 (e.g., the Factory Interface module 214 of the computing system 200) may receive a request related to a project. The project may be a construction project, a manufacturing project, and/or a combination thereof. The computing system 200 may further determine one or more project objectives related to the request, and a set of constraints for the project. The set of constraints may be derived at least through a knowledge repository that includes one or more of parameters related to the project and a data feed from a plurality of data sources associated with the project. The computing system 200 may correlate the determined set of constraints with the one or more project objectives, and evaluate the correlated set of constraints and the one or more project objectives to generate an optimized model. Finally, at step S802, the computing system 200 may create a project manifest based on the optimized model for executing the project.

In step S804, the computing system 200 (e.g., the Optimizer module 216 of the computing system 200) may achieve custom project objectives associated with a manufacturing and/or a construction project. The computing system 200 may analyze real-time data and user modification, if any, associated with the set of constraints determined in step S802. The computing system 200 may determine an impact of the analyzed data and user modification on the one or more project objectives determined in step S802. The computing system 200 may generate an updated project manifest based on the determined impact.

In step S806, the computing system 200 (e.g., the Monitor Production Efficiencies module 218 of the computing system 200) may monitor production efficiency associated with the manufacturing and/or the construction project. The computing system 200 may provide one or more of a causality data and a remedial data associated with the production efficiency, as discussed above.

In step S808, the computing system 200 (e.g., the Interface to Master Schedule module 220 of the computing system 200) may monitor real-time data associated with the manufacturing and/or the construction project, and on detecting an event that may cause a delay, updating schedules associated with different stages of the project based on the impact of the detected event.

In step S810, the computing system 200 (e.g., the Delivery Logistics module 222 of the computing system 200) may provide suggestions, outcomes, and deadlines regarding delivery of work products at each stage (phase) of a construction and/or a manufacturing project.

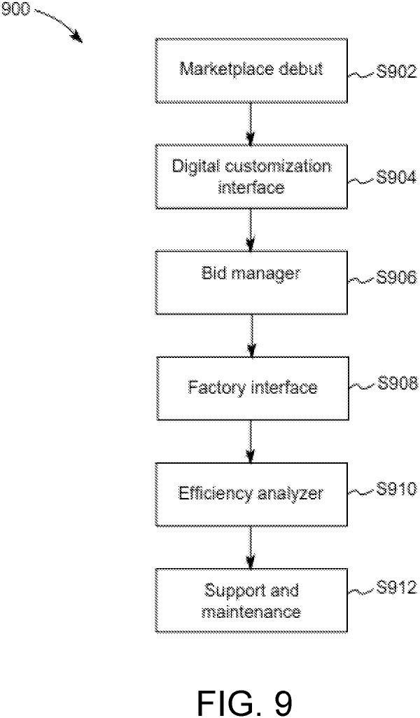

FIG. 9 is another exemplary flowchart 900 illustrating various subsystem modules and method steps managing bidding related to a construction and/or a manufacturing project, according to an embodiment. FIG. 9 discusses the various operations performed by the computing system 200 and/or an apparatus associated with the computing system 200 (simply referred herein to as computing system 200 for clarity) for providing a set of recommendations, according to an embodiment.

In step S902, the computing system 200 (e.g., the Marketplace Debut module 224 of the computing system 200) may receive a bidding request for a request related to the project from one or more bidders who intend to work on the project. The project may refer to a manufacturing project, a construction project, and/or a combination thereof. The computing system 200 may generate an optimized model associated with the project, based on the techniques discussed above. The computing system 200 may provide a set of recommendations to the one or more bidders based on the generated optimized model associated with the project.

In step S904, the computing system 200 (e.g., the Digital Customization Interface module of 226 the computing system 200) may provide an interface for users to customize pre-existing project and/or artefacts available for sale, for example, on the digital marketplace.

In step S906, the computing system 200 (e.g., the Bid Manager module 228 of the computing system 200) may receive bids related to the project from the one or more bidders based on the set of recommendations provided by the computing system 200. The computing system 200 may further arrange the received bids based on the one or more project objectives. The computing system 200 may provide the arranged bids related to the project on a digital marketplace interface.

In step S908, the computing system 200 (e.g., the Factory Interface module 230 of the computing system 200) may generate a project manifest associated with the project for which the one or more bids were received by the computing system 200.

In step S910, the computing system 200 (e.g., the Efficiency Analyzer module 232 of the computing system 200) may monitor production efficiencies associated with the project for which the one or more bids were received by the computing system 200. The computing system 200 may provide a causality data and /or a remedial data associated with the monitored production efficiency to a user, such as, a bidder.

In step S912, the computing system 200 (e.g., the Support and Maintenance module 234 of the computing system 200) may output one or more suggestions on how to provide support and maintenance of the project.

### 7.0 Other Aspects of Disclosure

In an embodiment, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

The terms “comprising,” “including,” and “having,” as used in the claim and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition, or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures, and techniques other than those specifically described herein can be applied to the practice of the invention as broadly disclosed herein without resort to undue experimentation. All art-known functional equivalents of methods, devices, device elements, materials, procedures, and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation. Additionally, it should be understood that the various embodiments of the networks, devices, and/or modules described herein contain optional features that can be individually or together applied to any other embodiment shown or contemplated here to be mixed and matched with the features of such networks, devices, and/or modules.

While the invention has been described with respect to a limited number of embodiments, those skilled in the art, having benefit of this disclosure, will appreciate that other embodiments can be devised which do not depart from the scope of the invention as disclosed herein.

I/We claim:

1. A method for creating a project manifest in a computing environment, the method comprising:
receiving a request related to a project, the project is at least one of a construction project and a manufacturing project;
determining one or more project objectives related to the request;
determining a set of constraints for the project, the set of constraints are derived at least through a knowledge repository that includes one or more of parameters related to the project and a data feed from a plurality of data sources associated with the project;
correlating the determined set of constraints with the one or more project objectives;
evaluating the correlated set of constraints and the one or more project objectives to generate an optimized model; and
creating a project manifest based on the optimized model for executing the project.

2. The method of claim 1, further comprising:
determining the one or more project objectives from at least one of: a time objective, a cost objective, a quality objective, a sustainability objective, an efficiency objective, and a health objective associated with the project.

3. The method of claim 1, further comprising:
determining the parameters related to the project based on at least one of: a historical data related to the project, an industry data associated with the project, an execution data for the project, and a forecast data associated with the project.

4. The method of claim 1, further comprising:
applying one or more of deep-learning, Artificial Intelligence (AI), and Machine Learning (ML) processes to generate the optimized model.

5. The method of claim 1, further comprising:
determining the set of constraints includes determining at least one of: pre-existing manufacturing data sets, supplier data sets, material data sets, geolocation data sets, and environmental data sets.

6. The method of claim 1, further comprising:
analyzing real-time data and user modification associated with the set of constraints for achieving custom project objectives;
determining an impact of the analyzed data on the one or more project objectives; and
generating an updated project manifest based on the determined impact.

7. The method of claim 1, further comprising creating the project manifest that includes the optimized model covering time, cost, and schedule aspects from at least one of project, manpower, equipment, source, material, logistics, and processes.

8. The method of claim 1, further comprising:
monitoring a production efficiency associated with the project; and
providing one or more of a causality data and a remedial data associated with the production efficiency.

9. The method of claim 1, further comprising:
receiving a bidding request for the request related to the project from one or more bidders who intend to work on the project; and
providing a set of recommendations to the one or more bidders based on the generated optimized model associated with the project.

10. The method of claim 9, further comprising providing the set of recommendations including at least one of: a cost forecast, a project manifest associated with the project, a time forecast, and materials supplier information.

11. A computing system for creating a project manifest in a computing environment, the computing system comprising:
one or more computer systems comprising one or more hardware processors and storage media; and
instructions, stored in the storage media, implementing a factory interface module, which when executed by the computing system, causes the computing system to:
receive a request related to a project, the project is at least one of a construction project and a manufacturing project;
determine one or more project objectives related to the request;
determine a set of constraints for the project, the set of constraints are derived at least through a knowledge repository that includes one or more of parameters related to the project and a data feed from a plurality of data sources associated with the project;
correlate the determined set of constraints with the one or more project objectives;
evaluate the correlated set of constraints and the one or more project objectives to generate an optimized model; and
create a project manifest based on the optimized model for executing the project.

12. The computing system of claim 11, further comprising:
instructions, stored in the storage media, implementing an optimizer module for achieving custom project objectives, which when executed by the computing system, causes the computing system to:
analyze real-time data and user modification associated with the set of constraints;
determine an impact of the analyzed data on the one or more project objectives; and
generate an updated project manifest based on the determined impact.

13. The computing system of claim 11, further comprising:
instructions, stored in the storage media, implementing a monitor production efficiencies module, which when executed by the computing system, causes the computing system to:
monitor production efficiency associated with the project; and
provide one or more of a causality data and a remedial data associated with the production efficiency.

14. The computing system of claim 11, wherein the factory interface module, when executed by the computing system, further causes the computing system to create the project manifest that includes the optimized model covering time, cost, and schedule aspects from at least one of project, manpower, equipment, source, material, logistics, and processes.

15. The computing system of claim 11, further comprising:
instructions, stored in the storage media, implementing a marketplace debut module, which when executed by the computing system, causes the computing system to:
receive a bidding request for the request related to the project from one or more bidders who intend to work on the project; and
provide a set of recommendations to the one or more bidders based on the generated optimized model associated with the project.

16. The computing system of claim 15, further comprising:
instructions, stored in the storage media, implementing a bid manager, which when executed by the computing system, causes the computing system to:
receive bids related to the project from the one or more bidders based on the set of recommendations provided by the marketplace debut module;
arrange the received bids based on the one or more project objectives; and
provide the arranged bids related to the project on a digital marketplace interface.

17. A non-transitory computer-readable storage medium, having stored thereon a computer-executable program which, when executed by at least one processor, causes the at least one processor to:
receive a request related to a project, the project is at least one of a construction project and a manufacturing project;
determine one or more project objectives related to the request;
determine a set of constraints for the project, the set of constraints are derived at least through a knowledge repository that includes one or more of parameters related to the project and a data feed from a plurality of data sources associated with the project;
correlate the determined set of constraints with the one or more project objectives;
evaluate the correlated set of constraints and the one or more project objectives to generate an optimized model; and
create a project manifest based on the optimized model for executing the project.

18. The non-transitory computer-readable storage medium of claim 17, the computer-executable program further causes the at least one processor to:
analyze real-time data and user modification associated with the set of constraints for achieving a custom project objective;
determine an impact of the analyzed data on the one or more project objectives; and
generate an updated project manifest based on the determined impact.

19. The non-transitory computer-readable storage medium of claim 17, the computer-executable program further causes the at least one processor to:
monitor a production efficiency associated with the project; and
provide one or more of a causality data and a remedial data associated with the production efficiency.

20. The non-transitory computer-readable storage medium of claim 17, the computer-executable program further causes the at least one processor to:
receive a bidding request for the request related to the project from one or more bidders who intend to work on the project; and
provide a set of recommendations to the one or more bidders based on the generated optimized model associated with the project.
